(19) United States
(12) Patent Application Publication
(10) Pub. No.: US 2013/0021218 A1
(43) Pub. Date: Jan. 24, 2013

(54) ANTENNA APPARATUS INCLUDING MULTIPLE ANTENNA ELEMENTS FOR SIMULTANEOUSLY TRANSMITTING OR RECEIVING MULTIPLE WIDEBAND RADIO SIGNALS

(71) Applicants: Kenichi Asanuma, Kyoto (JP); Atsushi Yamamoto, Kyoto (JP); Tsutomu Sakata, Osaka (JP)

(72) Inventors: Kenichi Asanuma, Kyoto (JP); Atsushi Yamamoto, Kyoto (JP); Tsutomu Sakata, Osaka (JP)

(21) Appl. No.: 13/638,788

(22) PCT Filed: Oct. 28, 2011
(86) PCT No.: PCT/JP2011/006056

§ 371 Date: Oct. 1, 2012

(30) Foreign Application Priority Data
Feb. 4, 2011 (JP) 2011-022278

(51) Int. Cl. H01Q 21/00

(52) U.S. Cl. 343/810; 343/893

(57) ABSTRACT

An antenna apparatus includes antenna elements, each made of a conductive plate. The antenna elements are provided along a reference axis passing through first and second positions of the antenna apparatus, and close to a section between the first and second positions. Each of the antenna elements has first and second portions along a circumference of the antenna element, the first portion is close to the reference axis and electromagnetically coupled to the other antenna element, and the second portion is remote from the reference axis. The first portions of the respective antenna elements are shaped so that the antenna elements are the closest to each other near the first position, and a distance between the antenna elements gradually increases from the first position to the second position. The antenna apparatus has feed points provided on the antenna elements, respectively, and near the first position.

### TECHNICAL FIELD

The present invention relates to an antenna apparatus mainly for use in mobile communication such as mobile phones, and relates to a wireless communication apparatus provided with the antenna apparatus.

### BACKGROUND ART

The size and thickness of portable wireless communication apparatuses, such as mobile phones, have been rapidly reduced. In addition, the portable wireless communication apparatuses have been transformed from apparatuses to be used only as conventional telephones, to data terminals for transmitting and receiving electronic mails and for browsing web pages of WWW (World Wide Web), etc. Further, since the amount of information to be handled has increased from that of conventional audio and text infoiniation to that of pictures and videos, a further improvement in communication quality is required. In such circumstances, there are proposed array antenna apparatuses capable of reducing electromagnetic coupling in a certain frequency band for high-speed wireless communication, and wideband antenna apparatuses having a wide operating bandwidth.

Patent Literature 1 discloses a multimode antenna apparatus provided with a plurality of antenna elements; and connecting elements electrically connecting the antenna elements. The multimode antenna apparatus can reduce electromagnetic coupling between the plurality of antenna elements at a specific frequency due to electrical currents flowing through the antenna elements and bypassing electrical currents flowing through the connecting elements, and can simultaneously transmit or receive a plurality of narrow-band radio signals.

Patent Literature 2 discloses a tapered slot antenna having radiation conductor elements, a distance between them gradually increasing towards a radiation opening located at one end of the slot. This tapered slot antenna can transmit and receive a single wideband signal because the radiation conductors are electromagnetically coupled to each other over a wide band.

Patent Literature 3 discloses an array antenna apparatus in which a plurality of tapered slot antennas are disposed, thus simultaneously transmitting or receiving a plurality of wideband radio signals.

### CITATION LIST

### Patent Literature

PATENT LITERATURE 1: U.S. Patent Application Publication No. 2008/0258991
PATENT LITERATURE 2: Japanese Patent Laid-open Publication No. 2009-005086
PATENT LITERATURE 3: U.S. Pat. No. 6,552,691

### Non-Patent Literature

NON-PATENT LITERATURE 1: Blanch, S. et al., “Exact representation of antenna system diversity performance from input parameter description”, Electronics Letters, Volume 39, Issue 9, pp. 705-707, May 2003

### SUMMARY OF INVENTION

### Technical Problem

In recent years, there has been an increasing need to increase the data transmission rate on mobile phones, and thus, a next generation mobile phone standard, 3G-LTE (3rd Generation Partnership Project Long Term Evolution) has been studied. According to 3G-LTE, as a new technology for an increased the wireless transmission rate, it is determined to use a MIMO (Multiple Input Multiple Output) antenna apparatus using a plurality of antennas to simultaneously transmit or receive a plurality of radio signal substreams by spatial division multiplexing. The MIMO antenna apparatus uses a plurality of antennas at each of a transmitter and a receiver, and spatially multiplexes data streams, thus increasing a transmission rate. Since the MIMO antenna apparatus causes the plurality of antennas to simultaneously operate at the same frequency, electromagnetic coupling between the antennas becomes very strong under circumstances where the antennas are disposed close to each other within a small-sized mobile phone. When the electromagnetic coupling between the antennas becomes strong, the radiation efficiency of the antennas degrades. As a result, received radio waves are weakened, thus reducing transmission rate. Hence, it is necessary to provide an low coupling array antenna in which a plurality of antennas are disposed close to each other. In addition, in order to implement spatial division multiplexing, it is necessary for the MIMO antenna apparatus to simultaneously transmit or receive a plurality of radio signals having a low correlation therebetween, by using different radiation patterns, polarization characteristics, or the like. Furthermore, a technique for increasing the bandwidth of antennas is required in order to increase communication rate.

The antenna apparatus of Patent Literature 1 can reduce electromagnetic coupling, but has a problem of the narrow operable frequency band due to the linear structure of the antenna elements.

The antenna apparatus of Patent Literature 2 can transmit or receive a wideband radio signal, but has a problem of being unable to simultaneously transmit or receive a plurality of wideband radio signals because there is only one feed point.

Hence, it may be possible to use an array antenna configuration in which a plurality of wideband antennas are disposed as in Patent Literature 3. However, since the area for disposing the antennas increases, the array antenna configuration is not suitable for small-sized wireless terminals such as mobile phones.

An object of the present invention is to solve the above-described problems, and to provide an antenna apparatus capable of ensuring isolation between antenna elements, and capable of simultaneously transmitting or receiving a plurality of wideband radio signals, while having a simple and small configuration, and to provide a wireless communication apparatus provided with such an antenna apparatus.

### Solution to Problem

According to an antenna apparatus of the first aspect of the present invention, the antenna apparatus is provided with at least two antenna elements, each made of a conductive plate having a circumference. The antenna elements are provided along a reference axis passing through a first position and a second position of the antenna apparatus, and are provided close to a section between the first position and the second position. Each of the antenna elements has a first portion and a second portion along the circumference of the antenna element, the first portion is close to the reference axis and electromagnetically coupled to the other antenna element, and the second portion is remote from the reference axis. The first portions of the respective antenna elements are shaped so that the antenna elements are the closest to each other near the first position, and a distance between the antenna elements gradually increases from the first position to the second position. The antenna apparatus has feed points provided on the antenna elements, respectively, and near the first position.

In the antenna apparatus, each of the feed points is provided close to the reference axis.

In the antenna apparatus, each of the feed points is provided at a distance from the reference axis.

In the antenna apparatus, the antenna elements simultaneously transmit or receive different radio signals when being excited through their respective feed points.

In the antenna apparatus, the antenna elements are symmetric about the reference axis.

In the antenna apparatus, the antenna elements are asymmetric about the reference axis.

In the antenna apparatus, each of the antenna elements has a slit in the first portion.

In the antenna apparatus, in each of the antenna elements, the slit has a portion extending toward a corresponding feed point.

The antenna apparatus is provided with two antenna elements, and a ground conductor made of a conductive plate. The two antenna elements are provided on the same plane as that of the ground conductor.

The antenna apparatus is provided with a ground conductor made of a conductive plate; two antenna elements provided in parallel so as to overlap on the ground conductor, with a distance from the ground conductor; and short-circuit conductors connecting the two antenna elements to the ground conductor, respectively, whereby the antenna apparatus is configured as a planar inverted-F antenna apparatus.

In the antenna apparatus, each of the antenna elements is a dipole antenna.

The antenna apparatus a ground conductor made of a conductive plate. The antenna elements are vertically provided on the ground conductor.

In the antenna apparatus, each of the antenna elements is bent at at least one position.

The antenna apparatus is further provided with an electromagnetic coupling adjuster element provided in the first portions of the respective antenna elements so as to connect the antenna elements with each other, and adjusting electromagnetic coupling between the antenna elements in a first frequency band. The electromagnetic coupling adjuster element forms a current path between any pair of a first and a second antenna element among the antenna elements, through which a current flows, the current substantially canceling out a current flowing through the second antenna element due to electromagnetic coupling between the first and second antenna elements, when feeding the first antenna element at a feed point in the first frequency band.

In the antenna apparatus, the electromagnetic coupling adjuster element is a low-coupling circuit including a plurality of circuit elements having susceptance values.

In the antenna apparatus, the electromagnetic coupling adjuster element includes a plurality of amplitude adjusters and a plurality of phase shifters.

In the antenna apparatus, the electromagnetic coupling adjuster element is a conductive element.

In the antenna apparatus, the conductive element is integrally formed with the antenna elements.

In the antenna apparatus, the electromagnetic coupling adjuster element includes a filter.

The antenna apparatus is provided with at least one additional electromagnetic coupling adjuster element provided in the first portions of the respective antenna elements so as to connect the antenna elements with each other, and adjusting electromagnetic coupling between the antenna elements in a frequency band different from the first frequency band.

According to a wireless communication apparatus of the second aspect of the present invention, the wireless communication apparatus is provided with an antenna apparatus of the first aspect of the present invention.

### Advantageous Effects of Invention

The antenna apparatus and wireless communication apparatus of the present invention can ensure isolation between the antenna elements in a wide band, while having a simple and small configuration. Furthermore, the antenna apparatus and the wireless communication apparatus can reduce a correlation coefficient between the antenna elements, thus simultaneously transmitting or receiving a plurality of wideband radio signals having a low correlation therebetween.

Furthermore, the antenna apparatus and wireless communication apparatus of the present invention can reduce electromagnetic coupling due to the tapered antenna elements and due to the electromagnetic coupling adjuster element provided between the antenna elements, thus further improving the isolation between the antenna elements.

### BRIEF DESCRIPTION OF DRAWINGS

FIG. 1 is a diagram showing a schematic configuration of an antenna apparatus according to a first embodiment of the present invention.

FIG. 2 is a diagram showing current paths of the antenna apparatus of FIG. 1.

FIG. 3 is a diagram showing a schematic configuration and current paths of an antenna apparatus according to a comparison example.

FIG. 4 is a diagram showing a schematic configuration and current paths of an antenna apparatus according to a first modified embodiment of the first embodiment of the present invention.

FIG. 5 is a diagram showing a schematic configuration and current paths of an antenna apparatus according to a second modified embodiment of the first embodiment of the present invention.

FIG. 6 is a diagram showing a schematic configuration of an antenna apparatus according to a third modified embodiment of the first embodiment of the present invention.

FIG. 7 is a diagram showing a schematic configuration of an antenna apparatus according to a fourth modified embodiment of the first embodiment of the present invention.

FIG. 8 is a diagram showing a schematic configuration of an antenna apparatus according to a fifth modified embodiment of the first embodiment of the present invention.

FIG. 9 is a diagram showing a schematic configuration of an antenna apparatus according to a sixth modified embodiment of the first embodiment of the present invention.

FIG. 10 is a diagram showing a schematic configuration of an antenna apparatus according to a seventh modified embodiment of the first embodiment of the present invention.

FIG. 11 is a diagram showing a schematic configuration of an antenna apparatus according to an eighth modified embodiment of the first embodiment of the present invention.

FIG. 12 is a graph schematically showing characteristics of VSWR versus frequency of the antenna apparatus of FIG. 1.

FIG. 13 is a graph schematically showing characteristics of VSWR versus frequency of the antenna apparatus of FIG. 11.

FIG. 14 is a diagram showing a schematic configuration of an antenna apparatus according to a ninth modified embodiment of the first embodiment of the present invention.

FIG. 15 is a diagram showing a schematic configuration of an antenna apparatus according to a tenth modified embodiment of the first embodiment of the present invention.

FIG. 16 is a diagram showing a schematic configuration of an antenna apparatus according to an eleventh modified embodiment of the first embodiment of the present invention.

FIG. 17 is a diagram showing a schematic configuration of an antenna apparatus according to a twelfth modified embodiment of the first embodiment of the present invention.

FIG. 18 is a diagram showing a schematic configuration of an antenna apparatus according to a thirteenth modified embodiment of the first embodiment of the present invention.

FIG. 19 is a diagram showing a schematic configuration of an antenna apparatus according to a second embodiment of the present invention.

FIG. 20 is a diagram showing current paths of the antenna apparatus of FIG. 19.

FIG. 21 is an equivalent circuit diagram showing a first implementation example of an electromagnetic coupling adjuster element D1 of FIG. 19.

FIG. 22 is an equivalent circuit diagram showing a second implementation example of the electromagnetic coupling adjuster element D1 of FIG. 19.

FIG. 23 is an equivalent circuit diagram showing a third implementation example of the electromagnetic coupling adjuster element D1 of FIG. 19.

FIG. 24 is an equivalent circuit diagram showing a fourth implementation example of the electromagnetic coupling adjuster element D1 of FIG. 19.

FIG. 25 is a diagram showing a schematic configuration of an antenna apparatus according to a first modified embodiment of the second embodiment of the present invention.

FIG. 26 is a diagram showing a schematic configuration of an antenna apparatus according to a second modified embodiment of the second embodiment of the present invention.

FIG. 27 is a diagram showing a schematic configuration of an antenna apparatus according to a third modified embodiment of the second embodiment of the present invention.

FIG. 28 is a diagram showing a schematic configuration of an antenna apparatus according to a fourth modified embodiment of the second embodiment of the present invention.

FIG. 29 is a diagram showing a schematic configuration of an antenna apparatus according to a fifth modified embodiment of the second embodiment of the present invention.

FIG. 30 is a diagram showing a schematic configuration of an antenna apparatus according to a sixth modified embodiment of the second embodiment of the present invention.

FIG. 31 is a diagram showing a schematic configuration of an antenna apparatus according to a seventh modified embodiment of the second embodiment of the present invention.

FIG. 32 is a diagram showing a schematic configuration of an antenna apparatus according to an eighth modified embodiment of the second embodiment of the present invention.

FIG. 33 is a diagram showing a schematic configuration of an antenna apparatus according to a ninth modified embodiment of the second embodiment of the present invention.

FIG. 34 is a diagram showing a schematic configuration of an antenna apparatus according to a tenth modified embodiment of the second embodiment of the present invention.

FIG. 35 is a circuit diagram showing a first implementation example of electromagnetic coupling adjuster elements D1 and D2 of FIG. 34.

FIG. 36 is a graph showing a second implementation example of the electromagnetic coupling adjuster elements D1 and D2 of FIG. 34.

FIG. 37 is a graph showing a third implementation example of the electromagnetic coupling adjuster elements D1 and D2 of FIG. 34.

FIG. 38 is a graph showing a fourth implementation example of the electromagnetic coupling adjuster elements D1 and D2 of FIG. 34.

FIG. 39 is a diagram showing a schematic configuration of an antenna apparatus according to an eleventh modified embodiment of the second embodiment of the present invention.

FIG. 40 is a diagram showing a schematic configuration of an antenna apparatus according to a twelfth modified embodiment of the second embodiment of the present invention.

FIG. 41 is an unfolded view showing a schematic configuration of an antenna apparatus according to a first comparison example.

FIG. 42 is a perspective view showing a schematic configuration of the antenna apparatus of FIG. 41.

FIG. 43 is a graph showing a reflection coefficient S11 and a transmission coefficient S21 of the antenna apparatus of FIG. 41.

FIG. 44 is a diagram showing a schematic configuration of an antenna apparatus according to a first implementation example of the present invention.

FIG. 45 is a perspective view showing a schematic configuration of the antenna apparatus of FIG. 44.

FIG. 46 is a graph showing a reflection coefficient S11 and a transmission coefficient S21 of the antenna apparatus of FIG. 44.

FIG. 47 is a diagram showing a schematic configuration of an antenna apparatus according to a second implementation example of the present invention.

FIG. 48 is a perspective view showing a schematic configuration of the antenna apparatus of FIG. 47.

FIG. 49 is a graph showing a reflection coefficient S11 and a transmission coefficient S21 of the antenna apparatus of FIG. 47.

FIG. 50 is a table showing a radiation efficiency of the antenna apparatuses of FIGS. 41, 44, and 47.

FIG. 51 is a diagram showing a schematic configuration of an antenna apparatus according to a third implementation example of the present invention.

FIG. 52 is an equivalent circuit diagram showing an electromagnetic coupling adjuster element D1 of FIG. 51.

FIG. 53 is a graph showing an electromagnetic coupling between antenna elements A1 and A2 of the antenna apparatus of FIG. 51.

FIG. 54 is a diagram showing a schematic configuration of an antenna apparatus of a second comparison example.

FIG. 55 is an equivalent circuit diagram showing an electromagnetic coupling adjuster element D1 of FIG. 54.

FIG. 56 is a graph showing an electromagnetic coupling between antenna elements A111 and A112 of the antenna apparatus of FIG. 54.

FIG. 57 is a graph showing a radiation efficiency of the antenna apparatuses of FIGS. 51 and 54.

FIG. 58 is a graph showing correlation coefficients of the antenna apparatuses of FIGS. 51 and 54.

FIG. 59 is a diagram showing a schematic configuration of an antenna apparatus according to a fourth implementation example of the present invention.

FIG. 60 is a graph showing a reflection coefficient S11 and a transmission coefficient S51 of the antenna apparatus of FIG. 59.

### DESCRIPTION OF EMBODIMENTS

Embodiments of the present invention will be described below with reference to the drawings. Note that like components are denoted by the same reference signs.

### First Embodiment

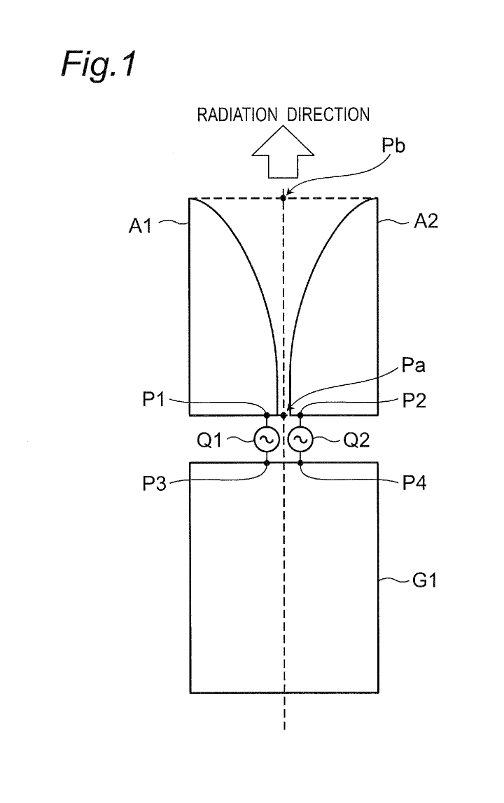

FIG. 1 is a diagram showing a schematic configuration of an antenna apparatus according to a first embodiment of the present invention. The antenna apparatus of the present embodiment is provided with: a ground conductor G1 made of a conductive plate; and two antenna elements A1 and A2, each made of a conductive plate. For example, the ground conductor G1 and the antenna elements A1 and A2 are provided on the same plane. The antenna elements A1 and A2 are provided along an imaginary reference axis (indicated by a vertical dashed line in FIG. 1) passing through a first reference point Pa and a second reference point Pb of the antenna apparatus, and are provided close to a section between the first reference point Pa and the second reference point Pb. Each of the antenna elements A1 and A2 has a first portion and a second portion along a circumference of the antenna element, the first portion is close to the reference axis and electromagnetically coupled to the other antenna element, and the second portion is remote from the reference axis. The first portions of the respective antenna elements A1 and A2 are shaped so that the antenna elements A1 and A2 are the closest to each other near the first reference point Pa, and a distance between the antenna elements A1 and A2 gradually increases from the first reference point Pa to the second reference point Pb (a tapered shape). Furthermore, the antenna apparatus has feed points P1 and P2 provided on the antenna elements A1 and A2, respectively, and near the first reference point Pa. Each of the feed points P1 and P2 is located preferably close to the reference axis. A feed portion including the feed points P1 and P2 is provided in a portion where the ground conductor G1 opposes to the antenna elements A1 and A2. In the feed portion, a first signal source Q1 is connected to the feed point P1 on the antenna element A1 and a ground point P3 on the ground conductor G1, and a second signal source Q2 is connected to the feed point P2 on the antenna element A2 and a ground point P4 on the ground conductor G1. The antenna elements A1 and A2 can simultaneously transmit (or receive) different radio signals (e.g., a plurality of radio signal substreams of MIMO communication) when being excited through their respective feed points P1 and P2.

According to the antenna apparatus of the present embodiment, even if the antenna elements A1 and A2 are close to each other, the antenna apparatus can operate while ensuring isolation between the antenna elements A1 and A2. The radiation direction of the antenna apparatus is, for example, a direction from a portion where the antenna elements A1 and A2 are the closest to each other, to an opening of the taper (i.e., a direction from the first reference point Pa to the second reference point Pb).

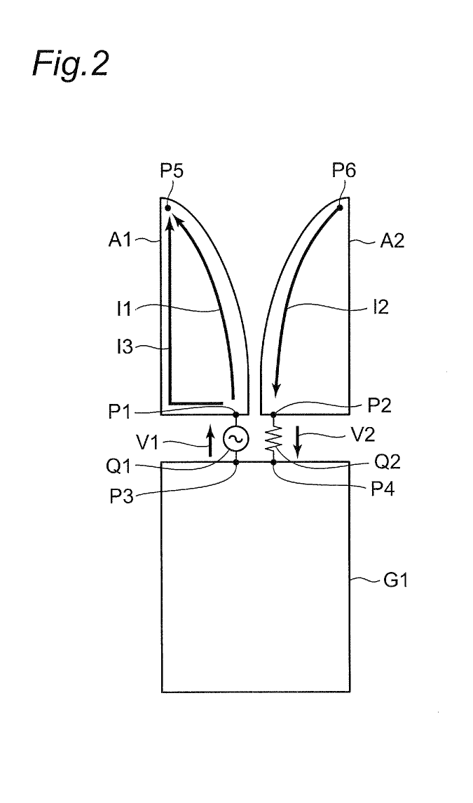

FIG. 2 is a diagram showing current paths of the antenna apparatus of FIG. 1. In the first portions of the antenna elements A1 and A2 (portions close to the reference line), the length from the feed point P1 of the antenna element A1 to an end point P5 in the radiation direction of the antenna element A1 is configured to be, for example, a length of about λ/4 of an operating wavelength λ, and similarly, the length from the feed point P2 of the antenna element A2 to an end point P6 in the radiation direction of the antenna element A2 is also configured to be, for example, a length of about λ/4. The current paths of FIG. 2 show the case in which only the signal source Q1 is in operation and the signal source Q2 is not in operation (therefore, in FIG. 2, the signal source Q2 is shown as a load). When the antenna element A1 is excited through the feed point P1 at voltage V1, a current I1 flows through the first portion of the antenna element A1 (a portion close to the reference line), and a current I3 flows through the second portion of the antenna element A1 (a portion remote from the reference line). At that time, electromagnetic coupling occurs between the antenna elements A1 and A2, and a counter electromotive force V2 is generated at the feed point P2. Hence, a current I2 opposite in phase to the current I1 on the antenna element A1 flows through the antenna element A2. According to the antenna apparatus of FIG. 1, the distance between the antenna elements A1 and A2 gradually increases from the first reference point Pa to the second reference point Pb, and accordingly, the electromagnetic coupling between the antenna elements A1 and A2 gradually decreases from the first reference point Pa to the second reference point Pb. Hence, it facilitates the spatial radiation of parts of the currents I1 and I2.

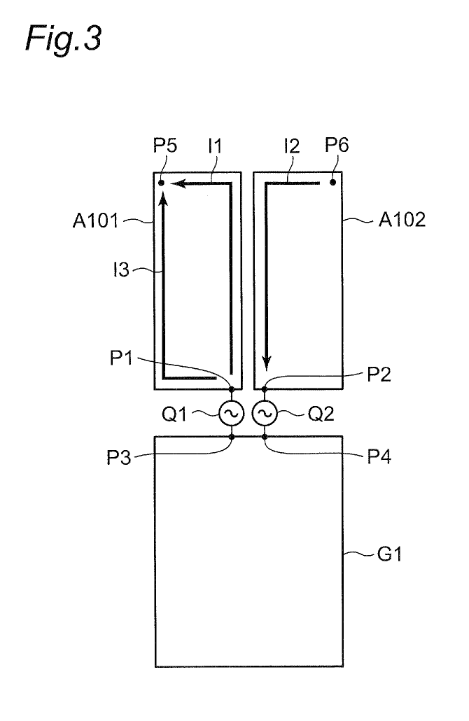

FIG. 3 is a diagram showing a schematic configuration and current paths of an antenna apparatus according to a comparison example. The antenna apparatus of FIG. 3 is provided with antenna elements A101 and A102, each made of a rectangular-shaped conductive plate. The antenna elements A101 and A102 are close to each other, with a certain distance provided therebetween. In the antenna apparatus of FIG. 3, when the antenna element A1 is excited through a feed point P1, currents I1 and I3 flow through the antenna element A1, and a current I2 flows through the antenna element A2 due to electromagnetic coupling between the antenna elements A1 and A2, as in the case of FIG. 2. In this case, each of the currents I1 and I2 has their maximum intensities near the feed points P1 and P2. If the currents I1 and I2 are not opposite in phase, then they contribute to radiation. However, since the currents I1 and I2 are opposite in phase, they cancel out each other. Thus, the antenna apparatus of FIG. 3 cannot achieve good radiation. On the other hand, the antenna apparatus of FIG. 1 can achieve good radiation while generating currents I1 and I2 opposite in phase, as described above.

Note that since the currents flowing through the antenna elements A1 and A2 are opposite in phase, the antenna apparatus of the present embodiment operates like a kind of tapered slot antenna (see, for example, Patent Literature 2), and thus, can efficiently transmit or receive wideband radio signals through the opening of the taper.

With respect to the operating wavelength λ, when the distance between the antenna elements A1 and A2 is at least partially, for example, λ/2π or less, strong electromagnetic coupling occurs between the antenna elements A1 and A2. Furthermore, when the distance between the antenna elements A1 and A2 is at least partially, for example, λ/10 or less, very strong electromagnetic coupling occurs between the antenna elements A1 and A2. Even if the antenna elements A1 and A2 are close to each other in such a manner, the antenna apparatus of the present embodiment can operate while ensuring isolation between the antenna elements A1 and A2.

FIG. 1 shows that in the first portions of the antenna elements A1 and A2, the portions where the distance between the antenna elements A1 and A2 gradually increases are curved. However, these portions may be linear, or may be, at least partially, curved and/or linear. In addition, although FIG. 1 shows that the ground conductor G1 is of a rectangular conductive plate, the ground conductor G1 is not limited to a rectangle, and may be any if other polygons, a circle, an ellipse, etc. In addition, the antenna elements A1 and A2 and the ground conductor G1 do not need to be provided on the same plane.

FIG. 1 and other drawings shows that the radiation direction of the antenna apparatus is identical to the direction from the first reference point Pa to the second reference point Pb. However, the radiation characteristic of the antenna apparatus is not limited thereto, and the antenna apparatus may have other radiation directions.

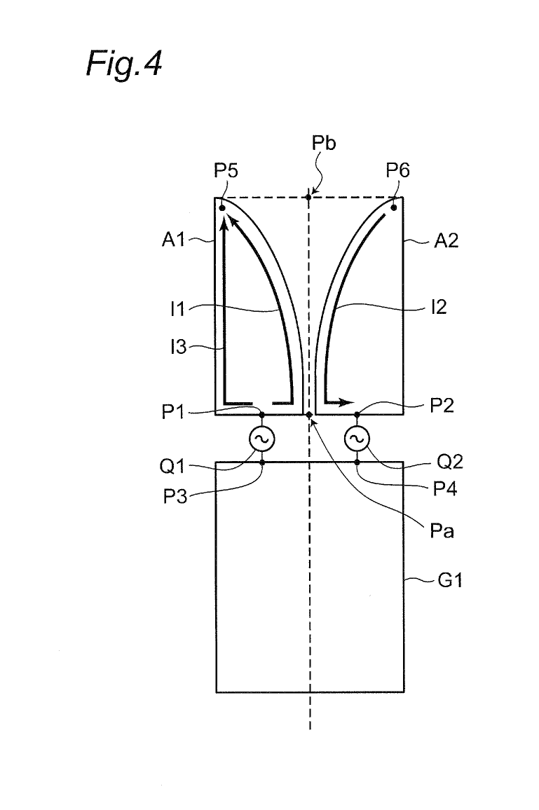

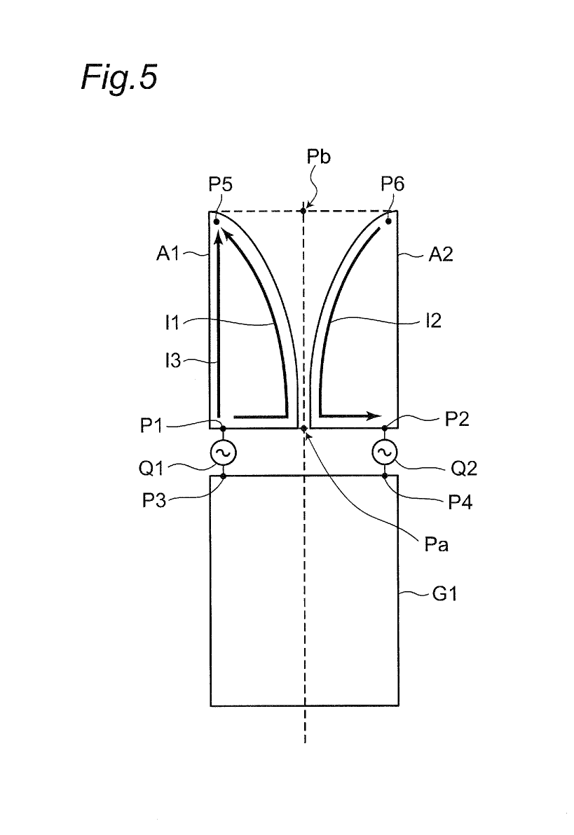

FIG. 4 is a diagram showing a schematic configuration and current paths of an antenna apparatus according to a first modified embodiment of the first embodiment of the present invention. FIG. 5 is a diagram showing a schematic configuration and current paths of an antenna apparatus according to a second modified embodiment of the first embodiment of the present invention. Each of feed points P1 and P2 may be provided at a certain distance from a reference axis, rather than being close to the reference axis. When each of the feed points P1 and P2 is provided close to the reference axis as shown in FIG. 1, since the phases of the currents I1 and I2 (see FIG. 2) are substantially opposite to each other, the antenna apparatus can operate in an operating mode similar to that of a tapered slot antenna, thus making it easier to ensure isolation. On the other hand, FIG. 4 shows the case in which feed points P1 and P2 are provided at a greater distance from a reference axis than that of FIG. 1, and FIG. 5 shows the case in which feed points P1 and P2 are provided at an even greater distance from a reference axis than that of FIG. 4. When the distance from the reference axis to the feed points P1 and P2 increases, the phases of the currents I1 and I2 are not completely opposite, and thus, isolation decreases. However, since the current path lengths from the feed points P1 and P2 to open ends P5 and P6 of antenna elements A1 and A2 increase, there is an advantageous effect that it becomes easier to achieve matching even in a low frequency band. In other words, the size of the antenna apparatus is reduced. The distances from the reference axis to the feed points P1 and P2 can be designed so as to be optimal at a target frequency, in consideration of a trade-off between isolation and matching.

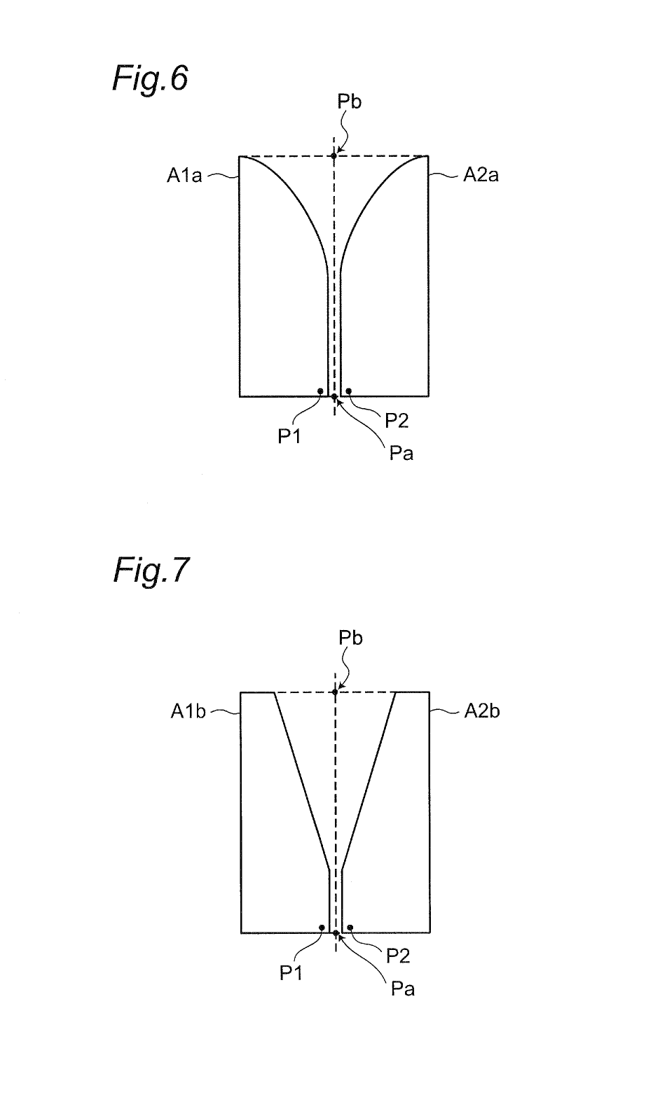

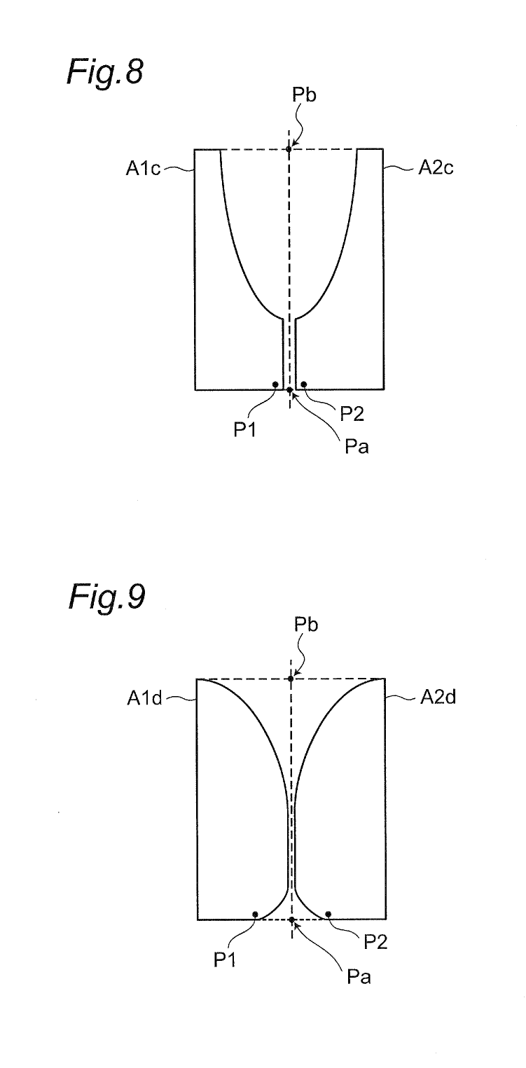

FIGS. 6 to 9 are diagrams showing schematic configurations of antenna apparatuses according to third to sixth modified embodiments of the first embodiment of the present invention. According to the antenna apparatus of FIG. 6, in first portions of antenna elements A1a and A2a (portions close to a reference line), the lengths of portions where the distance between the antenna elements A1a and A2a gradually increases are reduced than that of the antenna apparatus of FIG. 1. Thus, the distance between the antenna elements Ala and A2a steeply increases than that of the antenna apparatus of FIG. 1. As a result, in the first portions of the antenna elements A1a and A2a of the antenna apparatus of FIG. 6, the lengths of portions where the antenna elements Ala and A2a are parallel to each other increase. In addition, according to the antenna apparatus of FIG. 7, in first portions of antenna elements A1b and A2b, portions where the distance between the antenna elements A1b and A2b gradually increases are linearly shaped. In addition, although the antenna apparatus of FIG. 1 is configured such that an angle between the antenna elements A1 and A2 gradually increases in the direction from the first reference point Pa to the second reference point Pb, the antenna apparatus of FIG. 8 is configured such that an angle between antenna elements A1c and A2c gradually decreases in a direction from a first reference point Pa to a second reference point Pb. In addition, according to the antenna apparatus of FIG. 9, antenna elements A1d and A2d are extended in a direction from a second reference point Pb to a first reference point Pa, and furthermore, the antenna elements A1d and A2d are shaped such that the distance between the antenna elements A1 and A2 gradually increases from a portion where the antenna elements A1d and A2d are the closest to each other, to the first reference point Pa. According to the antenna apparatus of FIG. 9, there is an advantageous effect of increasing the lengths of paths of currents flowing through the antenna elements A1d and A2d, thus achieving operation at lower frequencies. The antenna apparatuses of FIGS. 6 to 9 can also obtain the same advantageous effect as that of the antenna apparatus of FIG. 1.

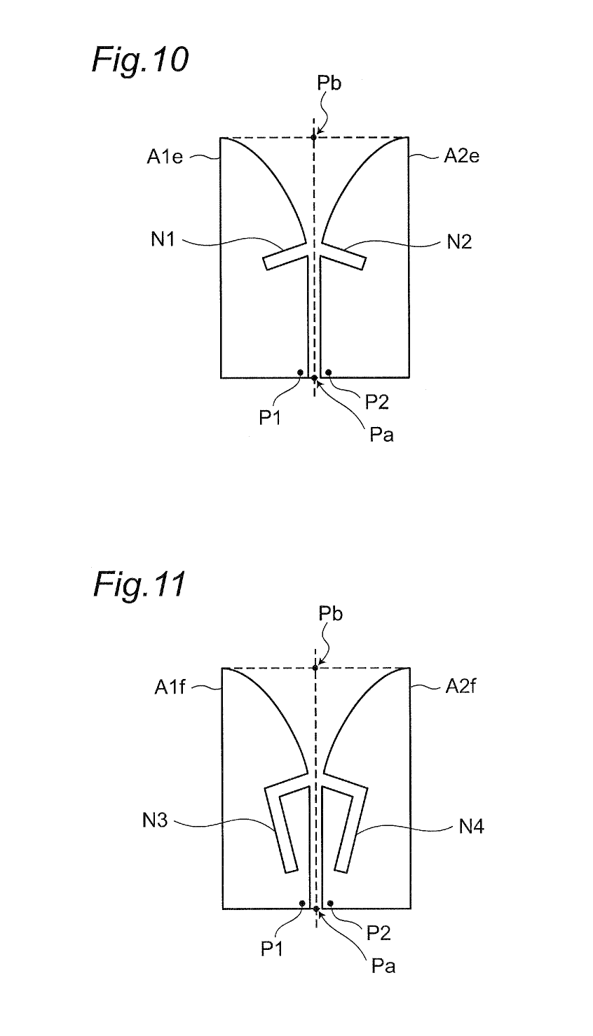

FIG. 10 is a diagram showing a schematic configuration of an antenna apparatus according to a seventh modified embodiment of the first embodiment of the present invention. The antenna apparatus of FIG. 10 has slits N1 and N2 provided in first portions of antenna elements A1e and A2e (portions close to a reference line). According to the antenna apparatus of FIG. 10, there is an advantageous effect of increasing the lengths of paths of currents flowing through the antenna elements A1e and A2e, thus achieving operation at lower frequencies. Note that a plurality of slits may be provided for each antenna element (corrugated antenna). In this case, the operating frequency can be further reduced than the case in which each antenna element has a single slit.

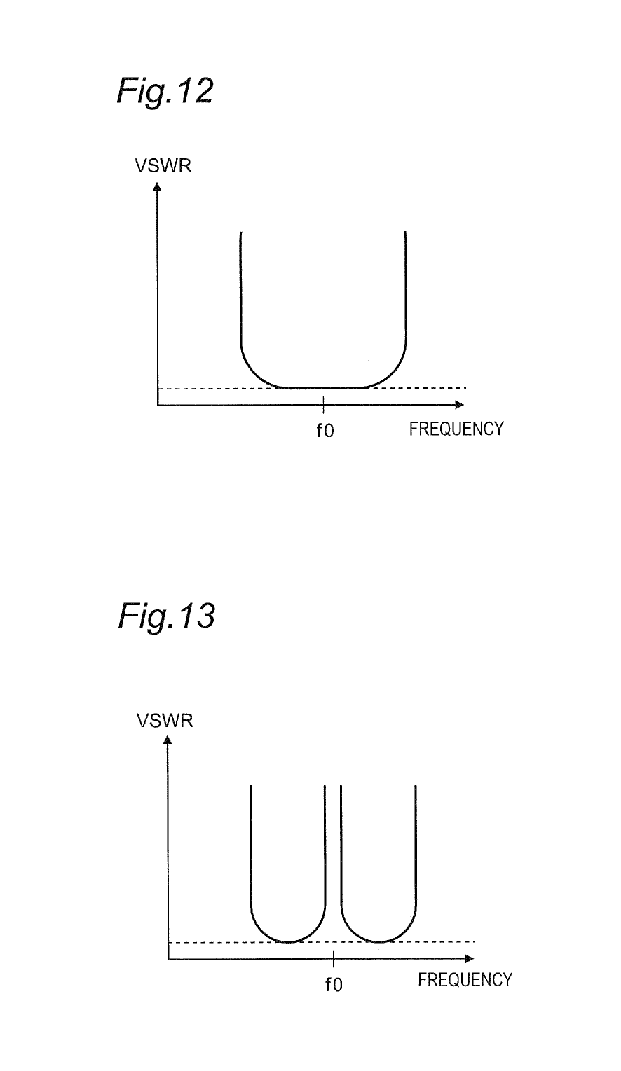

FIG. 11 is a diagram showing a schematic configuration of an antenna apparatus according to an eighth modified embodiment of the first embodiment of the present invention. FIG. 12 is a graph schematically showing characteristics of VSWR versus frequency of the antenna apparatus of FIG. 1. FIG. 13 is a graph schematically showing characteristics of VSWR versus frequency of the antenna apparatus of FIG. 11. The antenna apparatus of FIG. 11 has slits N3 and N4 having portions extending toward feed points P1 and P2 in first portions of antenna elements A1f and A2f (portions close to a reference line), rather than the slits N1 and N2 of FIG. 10. The slit lengths of the slits N3 and N4 are configured to be λ/4 of an operating wavelength λ. As described above, the first portions of the antenna elements A1e and A2e of the antenna apparatus of FIG. 10 are provided with the slits N1 and N2 to increase the lengths of the paths of currents flowing through the antenna elements A1e and A2e, thus achieving operation at lower frequencies. According to the antenna apparatus of FIG. 11, there is an advantageous effect of bandstop at a frequency f0 at which the slit lengths of the slits N3 and N4 are λ/4, thus suppressing unwanted radiation.

The shapes of the antenna elements of FIGS. 6 to 11 may be combined with each other.

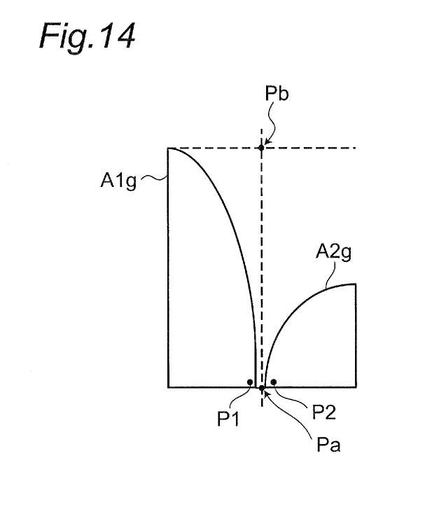

FIG. 14 is a diagram showing a schematic configuration of an antenna apparatus according to a ninth modified embodiment of the first embodiment of the present invention. Although the antenna apparatus of FIG. 1 is shown such that the antenna elements A1 and A2 are symmetric about the reference axis, the embodiment of the present invention is not limited thereto. The antenna apparatus of FIG. 14 is configured such that antenna elements A1g and A2g have different shapes and are asymmetric about a reference axis. Thus, by making the two antenna elements A1g and A2g asymmetric, the radiation patterns of the antenna elements A1g and A2g are made asymmetric, thus reducing the three-dimensional correlation between radio signals transmitted or received by the antenna elements A1g and A2g.

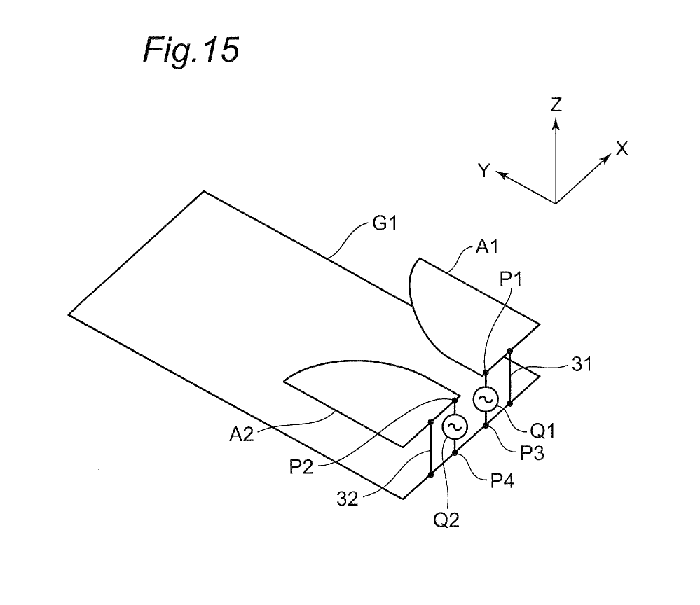

FIG. 15 is a diagram showing a schematic configuration of an antenna apparatus according to a tenth modified embodiment of the first embodiment of the present invention. The antenna apparatus of FIG. 15 is configured as a planar inverted-F antenna apparatus. According to the antenna apparatus of FIG. 15, antenna elements A1 and A2 and a ground conductor G1 are provided in parallel so as to overlap each other, with a certain distance therebetween. Furthermore, short-circuit conductors 31 and 32 are connected between the antenna elements A1 and A2 and the ground conductor G1, respectively. Thus, by configuring the antenna apparatus of the FIG. 15 as a planar inverted-F antenna apparatus, it is possible to further reduce the size and profile of the antenna apparatus than the antenna apparatus of FIG. 1. Note that the short-circuit conductors 31 and 32 are required for impedance adjustment, but may be omitted depending on the configuration of the antenna apparatus.

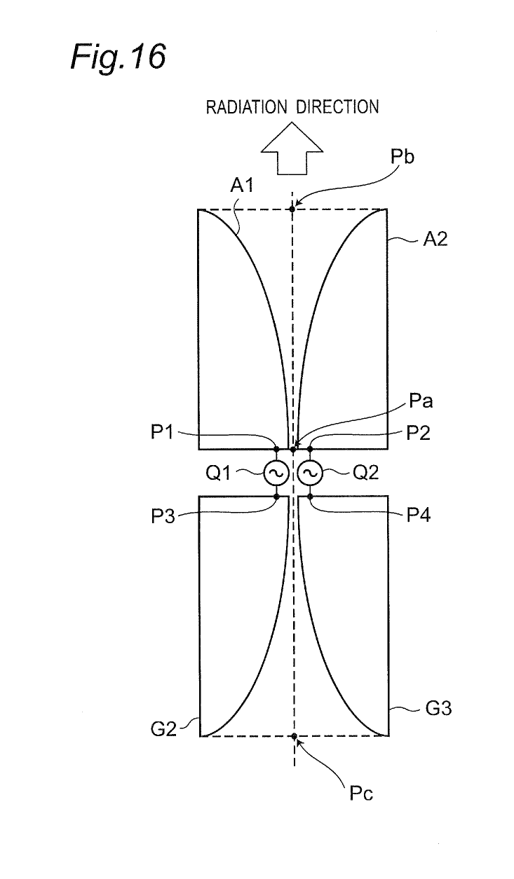

FIG. 16 is a diagram showing a schematic configuration of an antenna apparatus according to an eleventh modified embodiment of the first embodiment of the present invention. A ground conductor is not limited to be made of a single conductive plate like the antenna apparatus of FIG. 1. The antenna apparatus of FIG. 16 is configured to be provided with, instead of the ground conductor G1 of FIG. 1, a ground conductor G2 for an antenna element A1, and a ground conductor G3 for an antenna element A2, and include a dipole antenna including the antenna element A1 and the ground conductor G2, and a dipole antenna including the antenna element A2 and the ground conductor G3. Each of the ground conductors G2 and G3 is made of a conductive plate. On a reference axis passing through a first reference point Pa and a second reference point Pb, a third reference point Pc is disposed on the opposite side of the second reference point Pb with respect to the first reference point Pa. The ground conductors G2 and G3 are provided along the reference axis, and close to a section between the first reference point Pa and the third reference point Pc. Each of the ground conductors G2 and G3 has a first portion and a second portion along a circumference of the ground conductor, the first portion is close to the reference axis and electromagnetically coupled to the other ground conductor, and the second portion is remote from the reference axis. The first portions of the respective ground conductors G2 and G3 are shaped so that the ground conductors G2 and G3 are the closest to each other near the first reference point Pa, and a distance between the ground conductors G2 and G3 gradually increases from the first reference point Pa to the third reference point Pc (tapered shape). By using the antenna apparatus of FIG. 16 to operate in a dipole mode, the antenna apparatus has an increased radiation resistance, thus achieving efficient radiation. Note that although the antenna apparatus of FIG. 16 is shown such that the ground conductors G2 and G3 are symmetric about the reference axis, the embodiment of the present invention is not limited thereto.

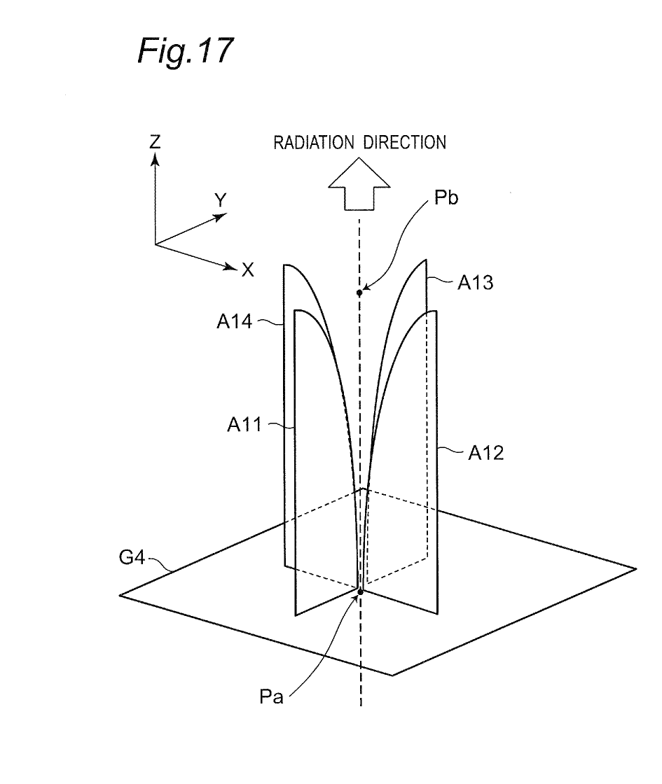

FIG. 17 is a diagram showing a schematic configuration of an antenna apparatus according to a twelfth modified embodiment of the first embodiment of the present invention. The embodiment of the present invention is not limited to a configuration with two antenna elements as described above, and three or more antenna elements may be provided. The antenna apparatus of FIG. 17 shows the case of four antenna elements A11 to A14. The antenna apparatus of FIG. 17 is provided with: a ground conductor G1 made of a conductive plate; and the antenna elements A11 to A14, each made of a conductive plate and vertically provided on the ground conductor G1. The antenna elements A11 to A14 are provided along an imaginary reference axis (indicated by a vertical dashed line in FIG. 1) passing through a first reference point Pa and a second reference point Pb of the antenna apparatus, and provided close to a section between the first reference point Pa and the second reference point Pb. Each of the antenna elements A11 to A14 has a first portion and a second portion along a circumference of the antenna element, the first portion is close to the reference axis and electromagnetically coupled to other antenna elements, and the second portion is remote from the reference axis. The first portions of the respective antenna elements A11 to A14 are shaped so that the antenna elements A11 to A14 are the closest to one another near the first reference point Pa, and the distances between any two of the antenna elements A11 to A14 gradually increase from the first reference point Pa to the second reference point Pb (tapered shape). Furthermore, the antenna apparatus has feed points (not shown) provided on the antenna elements A11 to A14, respectively, and near the first reference point Pa. Each feed point is located preferably close to the reference axis. The antenna elements A11 to A14 are provided along the reference axis, with an angle of preferably 90 degrees with respect to each other. According to the antenna apparatus of the present embodiment, it is possible to increase communication rate by increasing the number of antenna elements.

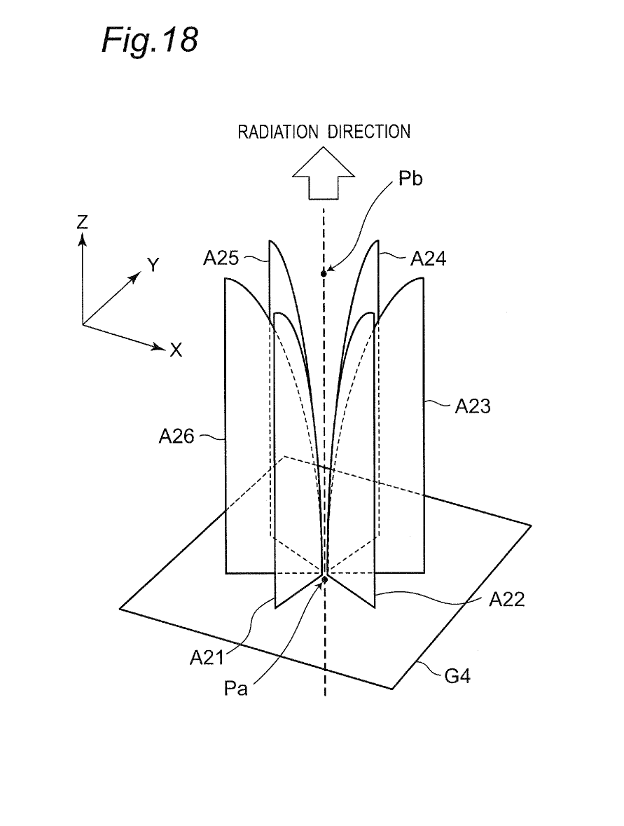

FIG. 18 is a diagram showing a schematic configuration of an antenna apparatus according to a thirteenth modified embodiment of the first embodiment of the present invention. The antenna apparatus of FIG. 18 shows the case of six antenna elements A21 to A26. The antenna elements A21 to A26 are provided along a reference axis, with an angle of preferably 60 degrees with respect to each other.

An antenna apparatus of the present embodiment is not limited to a configuration with two, four, or six antenna elements, and may be provided with a different number of antenna elements. In addition, although FIGS. 17 and 18 show the antenna elements A11 to A14 and A21 to A26 with the same shape as those of the antenna elements A1 and A2 of FIG. 1, it is also possible to use antenna elements with other shapes, e.g., those shown in FIGS. 6 to 10.

### Second Embodiment

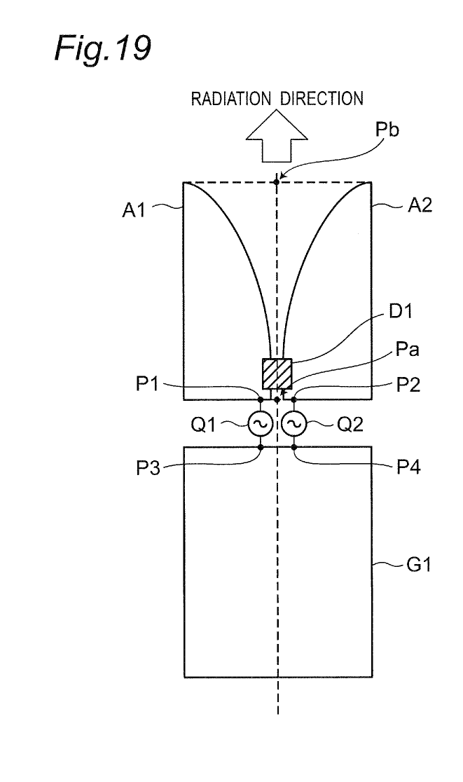

FIG. 19 is a diagram showing a schematic configuration of an antenna apparatus according to a second embodiment of the present invention. The antenna apparatus of the present embodiment is configured in a manner similar to that of the antenna apparatus of FIG. 1, and further provided with an electromagnetic coupling adjuster element D1. The electromagnetic coupling adjuster element D1 is provided in first portions of antenna elements A1 and A2 (portions close to a reference line) so as to connect the antenna elements A1 and A2 with each other, and adjusts the electromagnetic coupling between the antenna elements A1 and A2 in a certain frequency band. The electromagnetic coupling adjuster element D1 forms a current path through which a current flows, the current substantially cancels out another current flowing through the antenna element A2 (or the antenna element A1), due to electromagnetic coupling between the antenna elements A1 and A2, when feeding the antenna element A1 at a feed point P1 (or feeding the antenna element A2 at a feed point P2) in a certain frequency band. The electromagnetic coupling between the antenna elements A1 and A2 can be reduced due to the current flowing through the electromagnetic coupling adjuster element D1. Since the antenna apparatus of the present embodiment is provided with the electromagnetic coupling adjuster element D1, it is possible to further improve the isolation between the antenna elements A1 and A2.

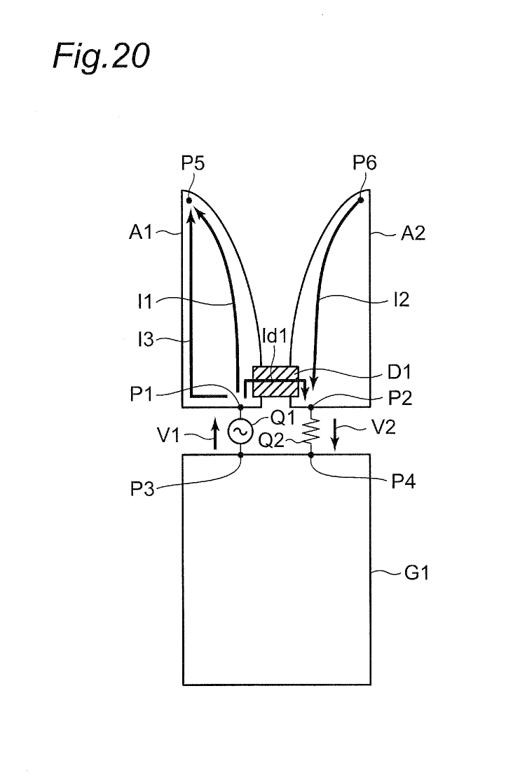

FIG. 20 is a diagram showing current paths of the antenna apparatus of FIG. 19. The current paths of FIG. 20 show the case in which only a signal source Q1 is in operation and a signal source Q2 is not in operation (therefore, in FIG. 20, the signal source Q2 is shown as a load). When the feed point P1 is excited at voltage V1, a current I1 flows through the first portion of the antenna element A1 (a portion close to the reference line), and a current I3 flows through a second portion of the antenna element A1 (a portion remote from the reference line). At that time, electromagnetic coupling occurs between the antenna elements A1 and A2, and a counter electromotive force V2 is generated at the feed point P2. Hence, a current I2 opposite in phase to the current I1 on the antenna element A1 flows through the antenna element A2. In order to cancel out this electromagnetic coupling, the electromagnetic coupling adjuster element D1 is provided to generate a current Id1=−12 flowing from the feed point P1 to the feed point P2 via the electromagnetic coupling adjuster element D1. Also in the case in which only the signal source Q2 is in operation and the signal source Q1 is not in operation, in order to cancel out electromagnetic coupling between the antenna elements A1 and A2, the electromagnetic coupling adjuster element D1 generates a current flowing from the feed point P2 to the feed point P1 via the electromagnetic coupling adjuster element D1. In addition, also in the case in which both of the signal sources Q1 and Q2 are in operation, the electromagnetic coupling adjuster element D1 generates a current for canceling out electromagnetic coupling between the antenna elements A1 and A2.

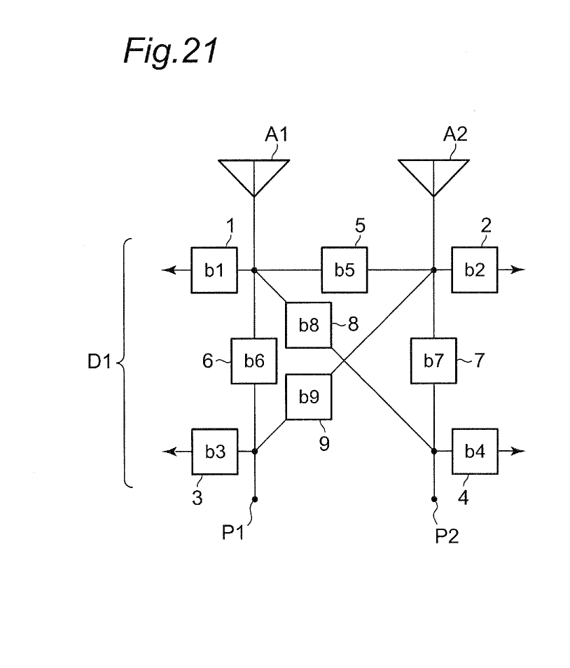

FIGS. 21 to 24 show some implementation examples of the electromagnetic coupling adjuster element D1 of FIG. 19.

FIG. 21 is an equivalent circuit diagram showing a first implementation example of the electromagnetic coupling adjuster element D1 of FIG. 19. The electromagnetic coupling adjuster element D1 of FIG. 21 is a low-coupling circuit including a plurality of susceptance elements 1 to 9 (circuit elements having susceptance values b1 to b9), and is suitable for size reduction. It is possible to increase the efficiency of the electromagnetic coupling adjuster element D1 by using, desirably, lossless inductors and/or capacitors to implement the susceptance elements 1 to 9. Due to such a configuration, the electromagnetic coupling adjuster element D1 generates a current for canceling out electromagnetic coupling between the antenna elements A1 and A2. Note that when the susceptance values b1 to b9 are considered to be substantially 0 at a design frequency, an open circuit can be used rather than the susceptance elements 1 to 9. In this case, it is possible to reduce the manufacturing cost of the antenna apparatus by reducing the number of circuit elements.

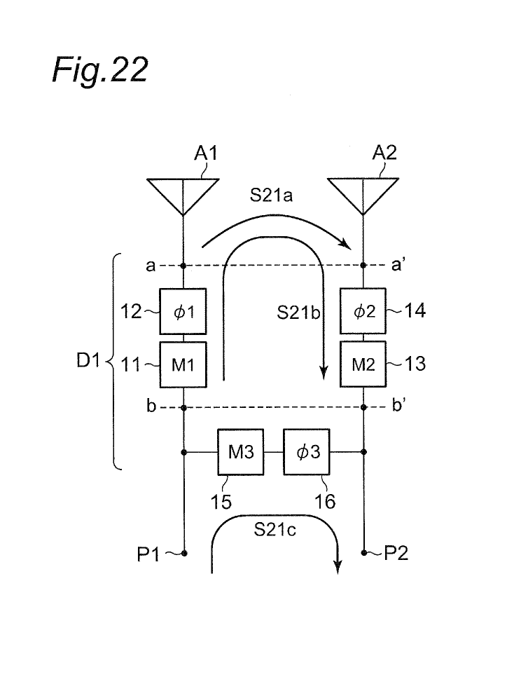

FIG. 22 is an equivalent circuit diagram showing a second implementation example of the electromagnetic coupling adjuster element D1 of FIG. 19. The electromagnetic coupling adjuster element D1 is not limited to a low-coupling circuit including the susceptance elements 1 to 9, and for example, as shown in FIG. 22, the electromagnetic coupling adjuster element D1 may be configured using amplitude adjusters 11, 13, and 15 and phase shifters 12, 14, and 16. For example, when the signal source Q1 is in operation, current paths from the feed point P1 to the feed point P2 include two current paths: a current path through electromagnetic coupling between the antenna elements A1 and A2, and a current path through the amplitude adjuster 15 and the phase shifter 16. In order to cancel out currents flowing through these current paths each other, amplitudes M1, M2, and M3 of the respective amplitude adjusters 11, 13, and 15, and the amounts of phase shift φ1, φ2, and φ3 of the respective phase shifters 12, 14, and 16 are adjusted. The conditions thereof are calculated by the following steps. S21a denotes the transmission coefficient between the antenna elements A1 and A2 above a reference line a-a′ of FIG. 22, S21b denotes the transmission coefficient between the antenna elements A1 and A2 above a reference line b-b′ of FIGS. 22, and S21c denotes the transmission coefficient between the feed points P1 and P2 passing through the amplitude adjuster 15 and the phase shifter 16. Note that in the following description, each equation is referred to by the number in parentheses indicated after the equation.

The transmission coefficient S21a between the antenna elements A1 and A2 is given by the following equation (1) using a amplitude M and a amount of phase shift φ.

S21a=M×exp(jφ) (1)

In addition, by adjusting the amplitudes M1, M2, and M3 of the respective amplitude adjusters 11, 13, and 15, and the amounts of phase shift φ1, φ2, and φ3 of the respective phase shifters 12, 14, and 16, the transmission coefficients S21b and S21c are given by the following equations (2) and (3).

$$\begin{matrix}S 21 b = S 21 a \times M 1 \times M 2 \times exp ( j ( φ1 + φ2 ) ) \\ = M \times M 1 \times M 2 \times exp ( j ( φ + φ1 + φ2 ) )\end{matrix} \qquad ( 2 )$$

S21c=M3×exp(jφ3) (3)

In this case, in order to set the transmission coefficient S21 between the feed points P1 and P2 to zero, the following equation (4) should be satisfied.

S21=S21b+S21c=0 (4)

By separately formulate conditions for amplitude characteristics and conditions for phase characteristics from the above equations, the following equations (5) and (6) are obtained.

φ3+=φ+φ1+φ2 (5)

M3=M1×M2×M (6)

When the equations (5) and (6) are satisfied, the transmission coefficient S21 between the feed points P1 and P2 becomes zero. By configuring the electromagnetic coupling adjuster element D1 so as to satisfy the equations (5) and (6), the electromagnetic coupling adjuster element D1 generates a current for canceling out electromagnetic coupling between the antenna elements A1 and A2.

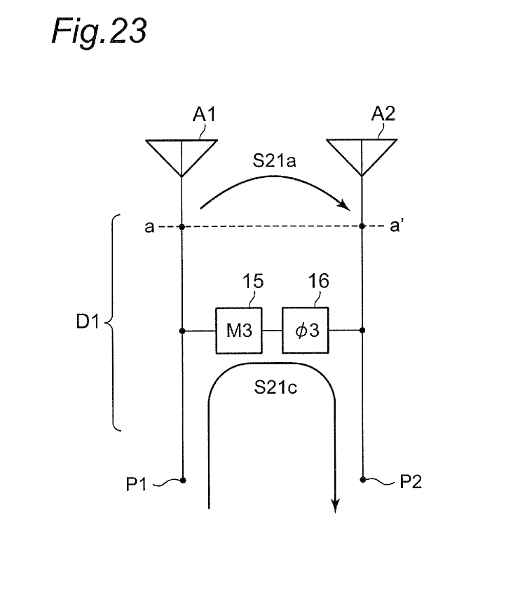

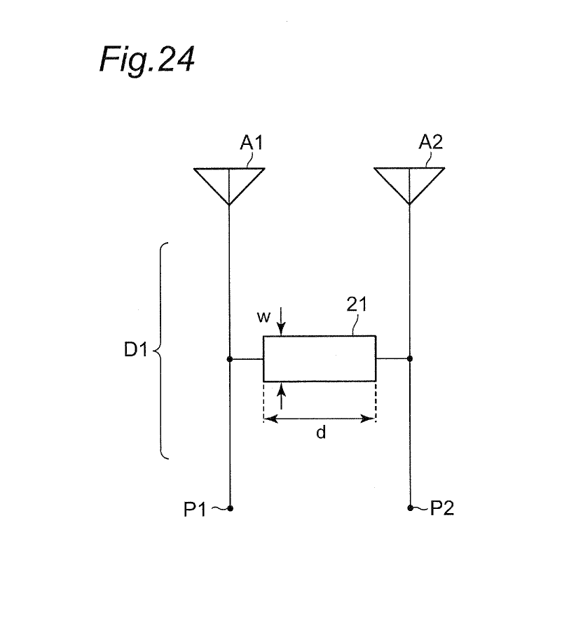

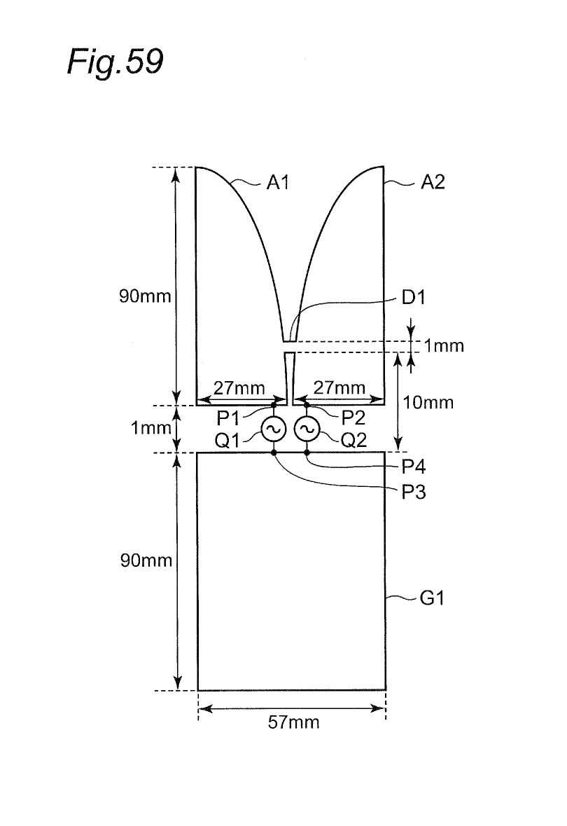

FIG. 23 is an equivalent circuit diagram showing a third implementation example of the electromagnetic coupling adjuster element D1 of FIG. 19. FIG. 24 is an equivalent circuit diagram showing a fourth implementation example of the electromagnetic coupling adjuster element D1 of FIG. 19. The electromagnetic coupling adjuster element D21 of FIG. 22 may be simplified as shown in FIG. 23. Furthermore, a circuit equivalent to the electromagnetic coupling adjuster element D1 of FIG. 23 may be configured using a conductive element 21 of FIG. 24, instead of an amplitude adjuster 15 and a phase shifter 16 of FIG. 23. According to the electromagnetic coupling adjuster element D1 of FIG. 24, the phase can be changed by changing an electrical length “d” of the conductive element 21, and the amplitude can be changed by changing a width “w” of the conductive element 21. Although a configuration using the conductive element 21 is not applicable to all antenna apparatuses, there is an advantageous effect of its simple structure and ease of fabrication. For example, as shown in FIG. 59, antenna elements A1 and A2 and a conductive element 21 may be integrally formed from a single conductive plate. Due to such a configuration, the electromagnetic coupling adjuster element D1 generates a current for canceling out electromagnetic coupling between the antenna elements A1 and A2.

In order to generate a current for canceling out electromagnetic coupling between the antenna elements A1 and A2, a combination of the electromagnetic coupling adjuster elements D1 of FIGS. 21 to 24 may be used.

Note that as another advantageous effect, the antenna apparatus of the present embodiment can reduce a correlation coefficient “ρ” defined by the following equation (7) (see Non-Patent Literature 1).

$$ρ = \frac{{\vert {S}_{11}^{*} {S}_{12} + {S}_{21}^{*} {S}_{22} \vert}^{2}}{( 1 - {\vert {S}_{11} \vert}^{2} - {\vert {S}_{21} \vert}^{2} ) ( 1 - {\vert {S}_{22} \vert}^{2} - {\vert {S}_{12} \vert}^{2} )} \qquad ( 7 )$$

By reducing the transmission coefficients between the feed points P1 and P2 (S₂₁, S₁₂) and reducing the reflection coefficients at the respective feed points P1 and P2 (S₁₁, S₂₂), the numerator of the above equation substantially approaches 0, and the denominator substantially approaches 1, thus reducing the correlation coefficient “ρ”. As a result, the antenna apparatus of the present embodiment can efficiently and simultaneously transmit or receive a plurality of wideband radio signals having a low correlation therebetween.

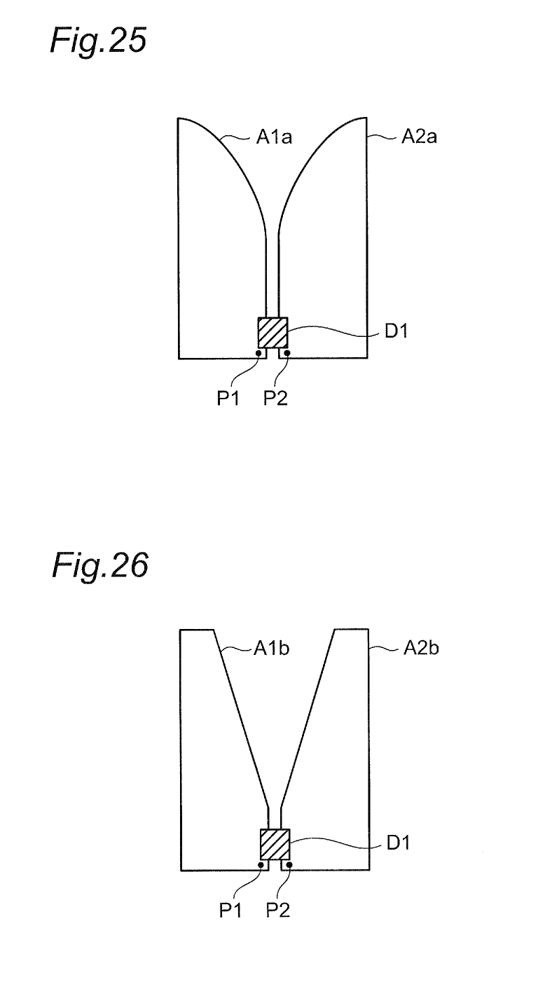

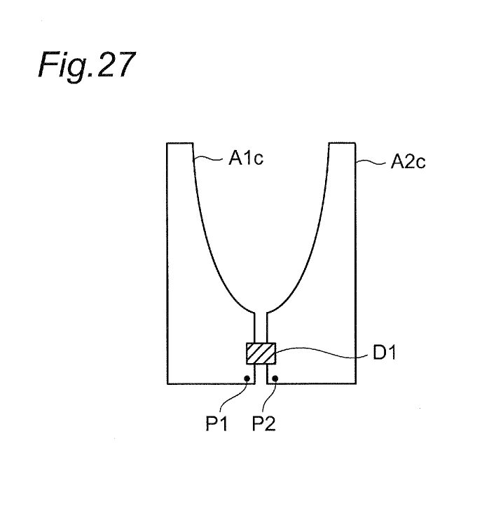

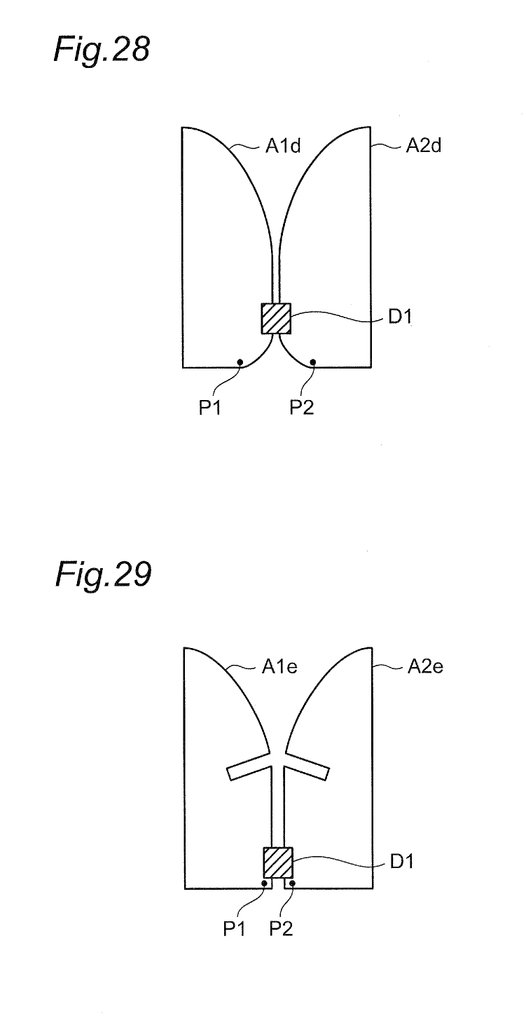

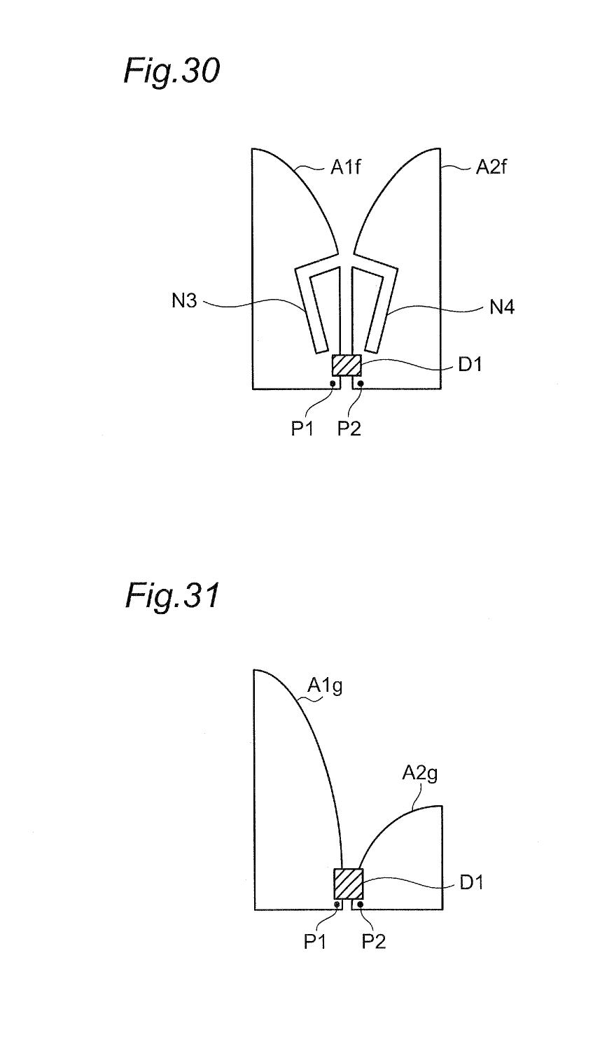

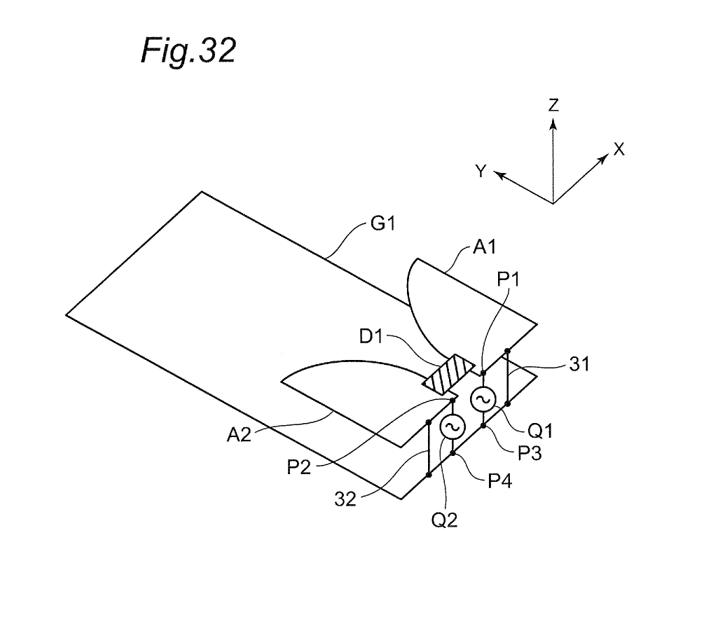

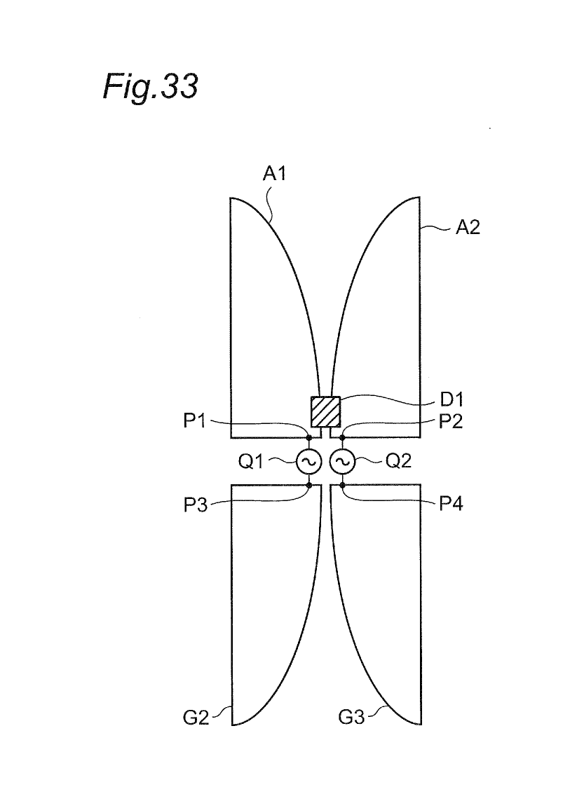

FIGS. 25 to 33 are diagrams showing schematic configurations of antenna apparatuses according to first to ninth modified embodiments of the second embodiment of the present invention. The antenna apparatuses of FIGS. 25 to 33 have configurations in which an electromagnetic coupling adjuster element D1 is added to the antenna apparatuses of FIGS. 6 to 11 and 14 to 16. The antenna apparatus of the modified embodiments can further improve the isolation between antenna elements A1 and A2 than that of the first embodiment due to the electromagnetic coupling adjuster element D1.

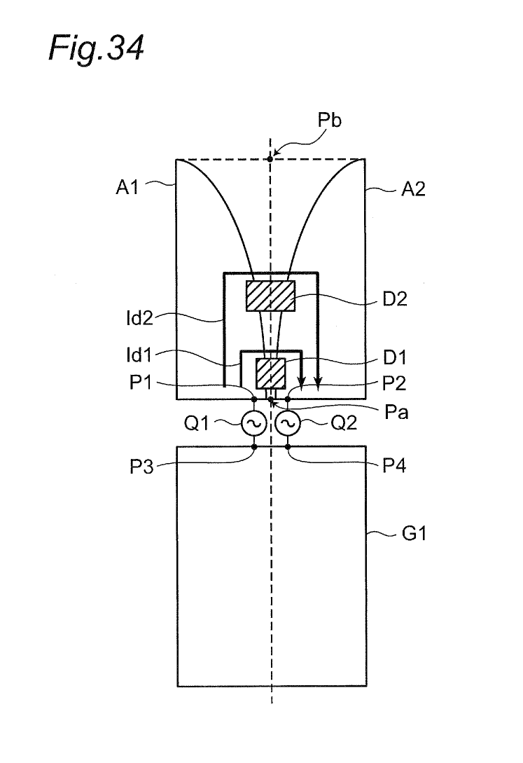

FIG. 34 is a diagram showing a schematic configuration of an antenna apparatus according to a tenth modified embodiment of the second embodiment of the present invention. The number of electromagnetic coupling adjuster elements for adjusting electromagnetic coupling between the antenna elements A1 and A2 is not limited to one, and the antenna apparatus of FIG. 34 is configured in a manner similar to that of the antenna apparatus of FIG. 19, and further provided with an additional electromagnetic coupling adjuster element D2 for adjusting electromagnetic coupling between antenna elements A1 and A2. The electromagnetic coupling adjuster element D2 is provided in first portions of the antenna elements A1 and A2 (portions close to a reference line) so as to connect the antenna elements A1 and A2 with each other, and provided more remote from feed points P1 and P2 than an electromagnetic coupling adjuster element D1. The electromagnetic coupling adjuster element D2 forms a current path through which a current Id2 flows, the current Id2 substantially cancels out a current flowing through the antenna element A2 (or the antenna element A1) due to electromagnetic coupling between the antenna elements A1 and A2, when feeding the antenna element A1 at the feed point P1 (or feeding the antenna element A2 at the feed point P2) in a lower frequency band than a frequency band used when a current path passing through the electromagnetic coupling adjuster element D1 is formed. Therefore, since the antenna apparatus of FIG. 34 is provided with the plurality of electromagnetic coupling adjuster elements D1 and D2, the antenna apparatus forms current paths between the antenna elements A1 and A2 in different frequency bands, and can reduce the electromagnetic coupling between the antenna elements A1 and A2 in the different frequency bands (and thus achieve multiband) due to the currents Id1 and Id2 flowing through the respective electromagnetic coupling adjuster elements D1 and D2.

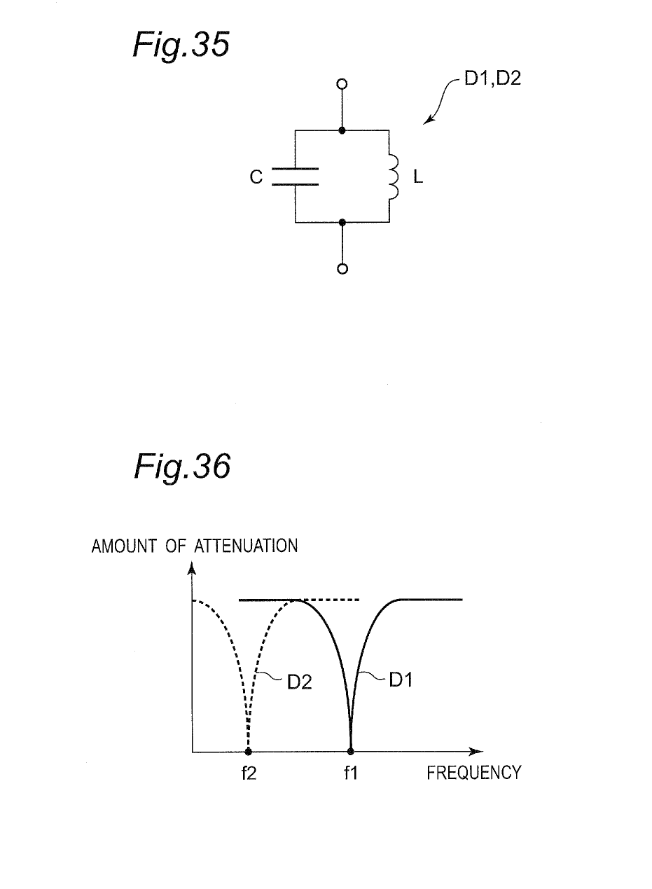

FIG. 35 is a circuit diagram showing a first implementation example of the electromagnetic coupling adjuster elements D1 and D2 of FIG. 34. For example, it is possible to use a resonant circuit including an inductor L and a capacitor C, for each of the electromagnetic coupling adjuster elements D1 and D2. In this case, the electromagnetic coupling adjuster element D1 can selectively pass only a current at the frequency f1, by setting values of circuit elements so as to pass a current at a frequency f1 and not to pass a current at a frequency f2 lower than the frequency f1. The electromagnetic coupling adjuster element D2 can selectively pass only a current at the frequency f2, by setting values of circuit elements so as to pass a current at the frequency f2 and not to pass a current at the frequency f1.

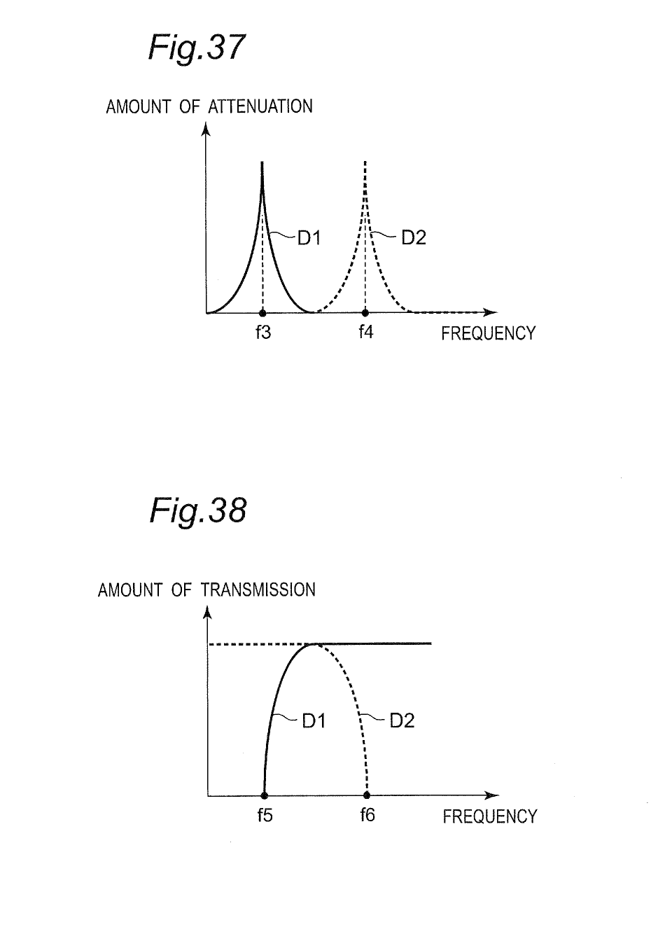

FIGS. 36 to 38 are graphs showing a second implementation example of the electromagnetic coupling adjuster elements D1 and D2 of FIG. 34. The implementation example of the electromagnetic coupling adjuster elements D1 and D2 is not limited to the circuit of FIG. 35, and may include a combination of a plurality of filters as shown in the graphs of FIGS. 36 to 38. FIG. 36 shows the case in which electromagnetic coupling adjuster elements D1 and D2 are configured as band-pass filters, the electromagnetic coupling adjuster element D1 passes a current at the frequency f1 and blocks a current at the frequency f2, and the electromagnetic coupling adjuster element D2 passes a current at the frequency f2 and blocks a current at the frequency f1. FIG. 37 shows the case in which the electromagnetic coupling adjuster elements D1 and D2 are configured as bandstop filters, the electromagnetic coupling adjuster element D1 blocks a current at a frequency f3 and passes a current at a frequency f4 higher than the frequency f3, and the electromagnetic coupling adjuster element D2 blocks a current at the frequency f4 and passes a current at the frequency f3. FIG. 38 shows the case in which the electromagnetic coupling adjuster element D1 is configured as a high-pass filter and the electromagnetic coupling adjuster element D2 is configured as a low-pass filter, the electromagnetic coupling adjuster element D1 passes a current at a frequency f6 and blocks a current at or lower than a frequency f5 lower than the frequency f6, and the electromagnetic coupling adjuster element D2 passes a current at the frequency f5 and blocks a current at or higher than the frequency f6.

The number of electromagnetic coupling adjuster elements is not limited to two or less, and similarly, three or more electromagnetic coupling adjuster elements may be provided.

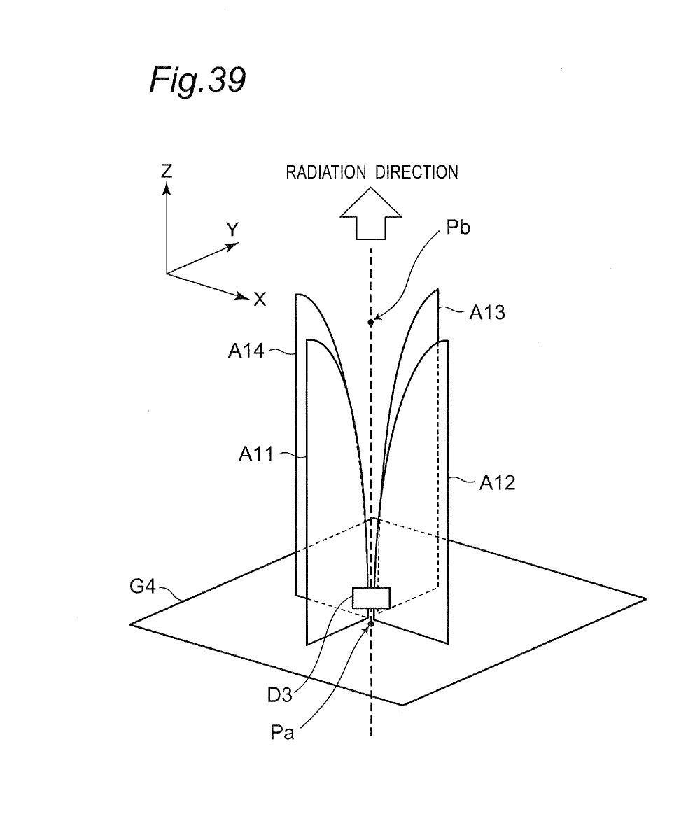

FIG. 39 is a diagram showing a schematic configuration of an antenna apparatus according to an eleventh modified embodiment of the second embodiment of the present invention. The antenna apparatus of FIG. 39 is configured in a manner similar to that of the antenna apparatus of FIG. 17, and further provided with an electromagnetic coupling adjuster element D3. The electromagnetic coupling adjuster element D3 is provided in first portions of antenna elements A11 to A14 (portions close to a reference line) so as to connect the antenna elements A11 to A14 with each other, and adjusts electromagnetic coupling among the antenna elements A11 to A14 in a certain frequency band. The electromagnetic coupling adjuster element D3 forms a current path between any pair of a first and a second antenna element among the antenna elements A11 to A14, through which a current flows, the current substantially cancels out a current flowing through the second antenna element due to electromagnetic coupling between the first and second antenna elements, when feeding the first antenna element at a feed point in a certain frequency band. The electromagnetic coupling among the antenna elements A11 to A14 can be reduced due to the current flowing through the electromagnetic coupling adjuster element D3. Since the antenna apparatus of FIG. 39 is provided with the electromagnetic coupling adjuster element D3, it is possible to further improve the isolation among the antenna elements A11 to A14 than that of the antenna apparatus of FIG. 17.

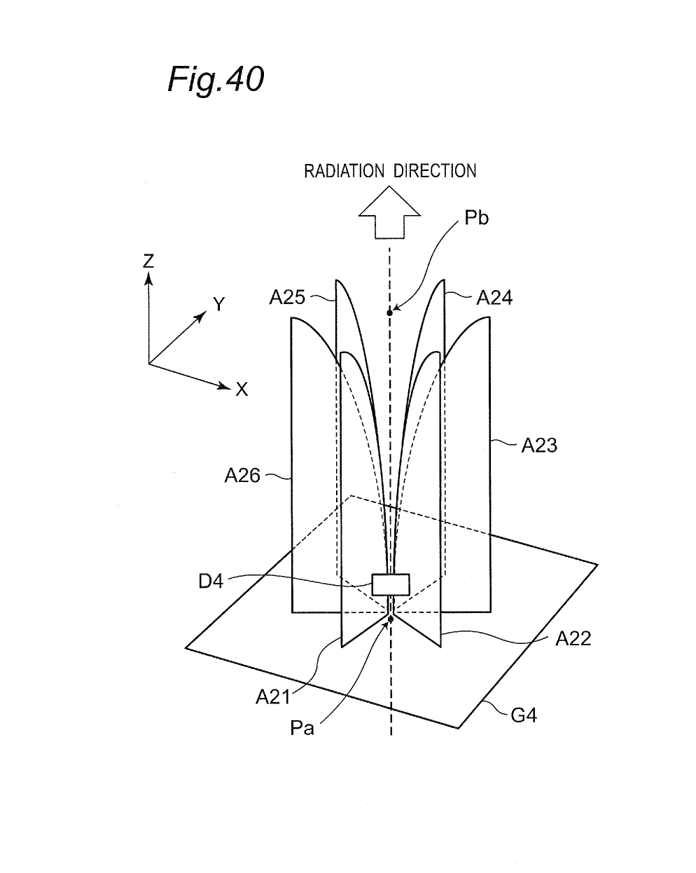

FIG. 40 is a diagram showing a schematic configuration of an antenna apparatus according to a twelfth modified embodiment of the second embodiment of the present invention. The antenna apparatus of FIG. 40 is configured in a manner similar to that of the antenna apparatus of FIG. 18, and further provided with an electromagnetic coupling adjuster element D4. The electromagnetic coupling adjuster element D4 is provided in first portions of antenna elements A21 to A26 (portions close to a reference line) so as to connect the antenna elements A21 to A26 with each other, and adjusts electromagnetic coupling among the antenna elements A21 to A26 in a certain frequency band. Since the antenna apparatus of FIG. 40 is provided with the electromagnetic coupling adjuster element D4, it is possible to further improve the isolation among the antenna elements A21 to A26 than that of the antenna apparatus of FIG. 18.

The above-described embodiments and modified embodiments may be combined.

### Implementation Example 1

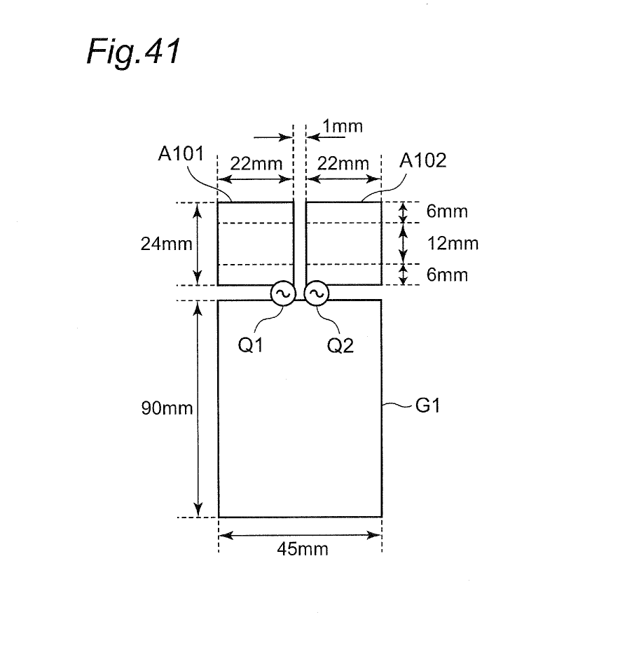

With reference to FIGS. 41 to 50, simulation results of antenna apparatuses according to the first embodiment of the present invention will be described below.

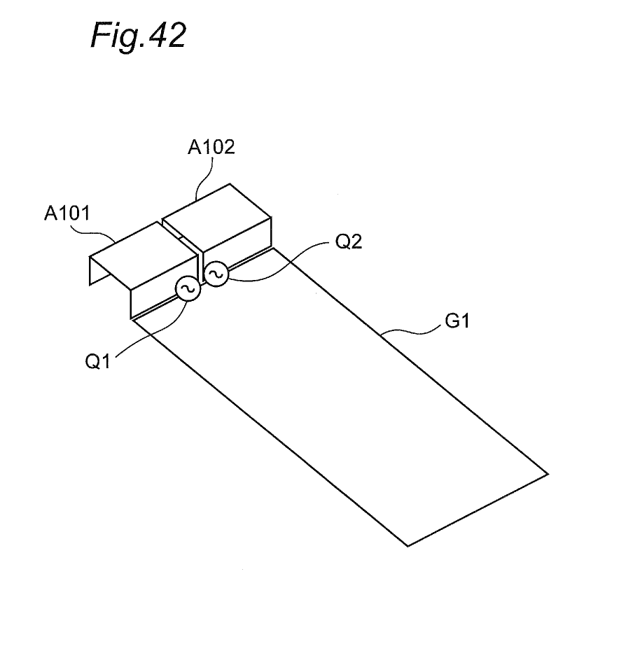

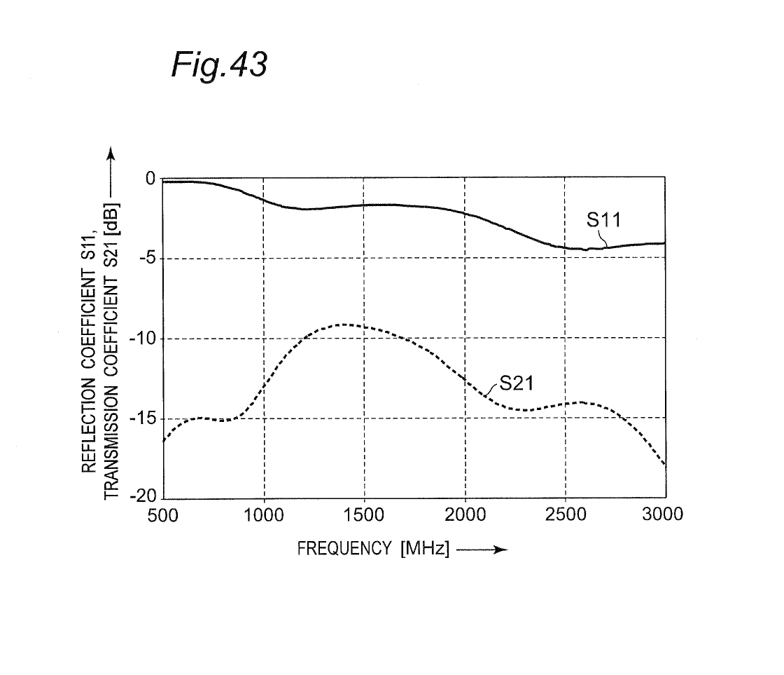

FIG. 41 is an unfolded view showing a schematic configuration of an antenna apparatus according to a first comparison example. FIG. 42 is a perspective view showing a schematic configuration of the antenna apparatus of FIG. 41. The antenna apparatus of FIG. 41 corresponds to the antenna apparatus according to the comparison example of FIG. 3. In the simulation, the antenna apparatus of FIG. 41 is bent along dashed lines on antenna elements A101 and A102, forming the antenna apparatus as shown in FIG. 42. Thus, the size of the antenna apparatus can be reduced. FIG. 43 is a graph showing a reflection coefficient S11 and a transmission coefficient S21 of the antenna apparatus of FIG. 41. In order to ensure isolation, the transmission coefficient S21 of −10 dB or less is desirable. Referring to FIG. 43, it can be seen that the antenna apparatus of FIG. 41 does not have sufficiently low transmission coefficient S21.

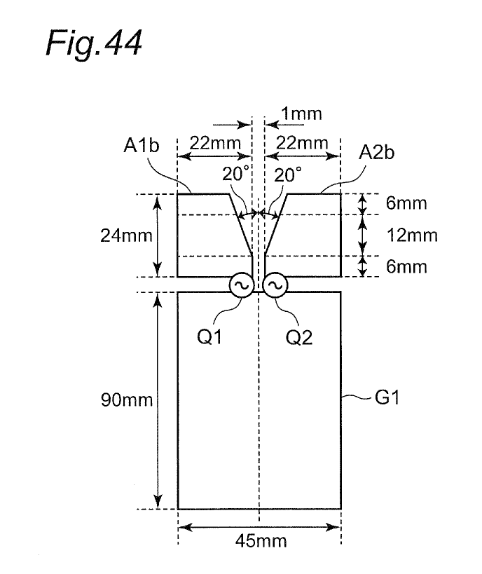

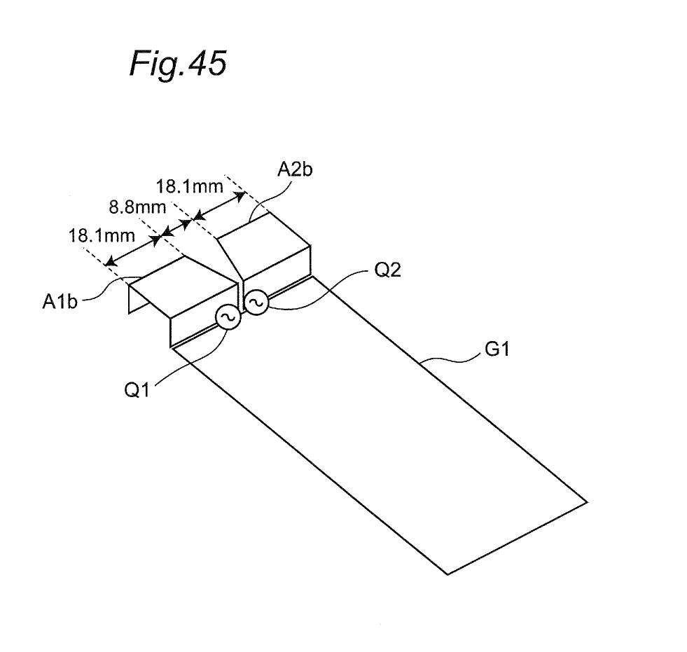

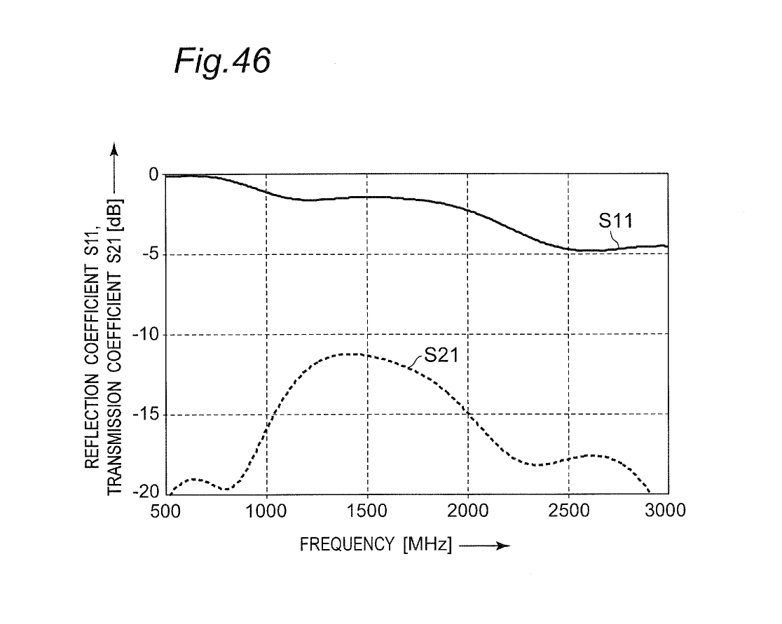

FIG. 44 is a diagram showing a schematic configuration of an antenna apparatus according to a first implementation example of the present invention. FIG. 45 is a perspective view showing a schematic configuration of the antenna apparatus of FIG. 44. The antenna apparatus of FIG. 44 corresponds to the antenna apparatus of FIG. 7. In the simulation, the antenna apparatus of FIG. 44 is bent along dashed lines on antenna elements A1b and A2b, forming the antenna apparatus as shown in FIG. 45. FIG. 46 is a graph showing a reflection coefficient S11 and a transmission coefficient S21 of the antenna apparatus of FIG. 44. Referring to FIG. 46, it can be seen that the antenna apparatus of FIG. 44 can reduce the transmission coefficient S21 over a wide band, compared to the antenna apparatus of FIG. 41.

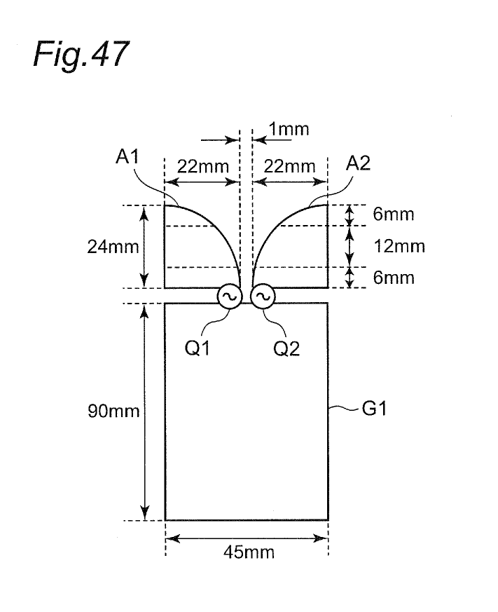

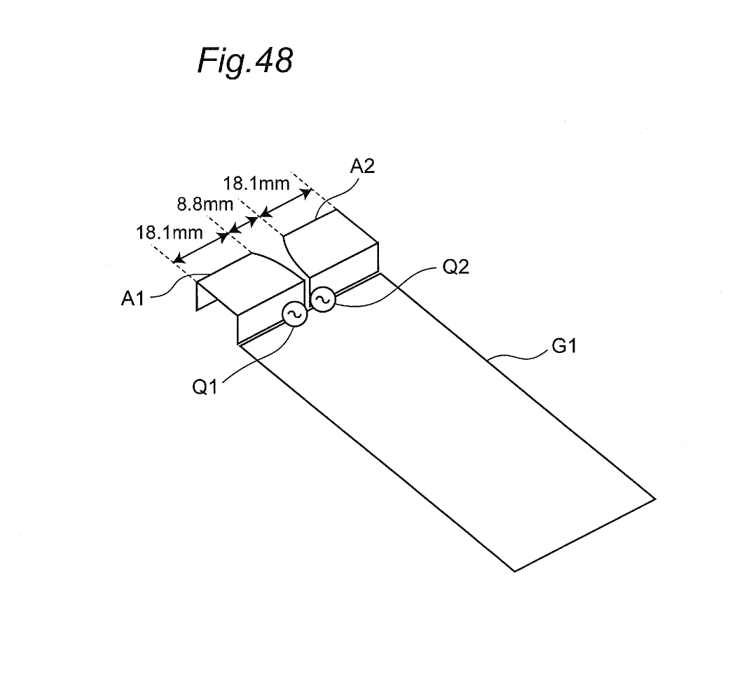

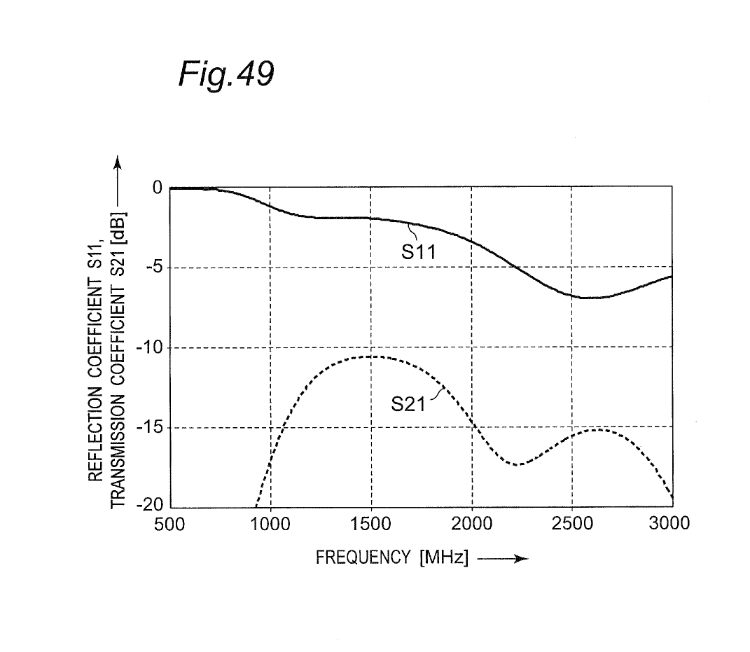

FIG. 47 is a diagram showing a schematic configuration of an antenna apparatus according to a second implementation example of the present invention. FIG. 48 is a perspective view showing a schematic configuration of the antenna apparatus of FIG. 47. The antenna apparatus of FIG. 47 corresponds to the antenna apparatus of FIG. 1. In the simulation, the antenna apparatus of FIG. 47 is bent along dashed lines on antenna elements A1 and A2, forming the antenna apparatus as shown in FIG. 48. FIG. 49 is a graph showing a reflection coefficient S11 and a transmission coefficient S21 of the antenna apparatus of FIG. 47. Referring to FIG. 48, it can be seen that the antenna apparatus of FIG. 47 can also reduce the transmission coefficient S21 over a wide band, compared to the antenna apparatus of FIG. 41. Furthermore, it can be seen that the antenna apparatus of FIG. 47 can also reduce the reflection coefficient S11, compared to the antenna apparatus of FIG. 44. It is understood that this is because the portions of the antenna apparatus of FIG. 44 where the distance between the antenna elements A1b and A2b gradually increases are linearly shaped, and on the other hand, the portions of the antenna apparatus of FIG. 44 where the distance between the antenna elements A1b and A2b gradually increases are curved and tapered, and thus, the operating mode of the antenna apparatus approaches a similar one to that of a tapered slot antenna.

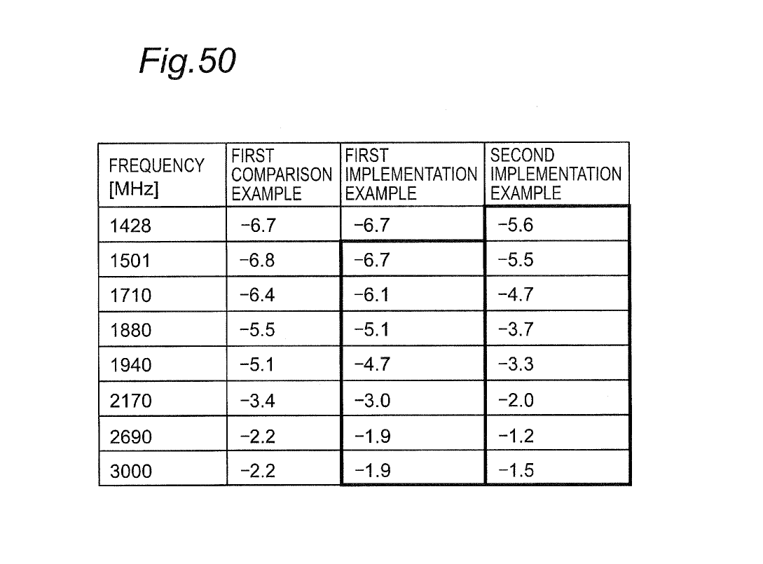

FIG. 50 is a table showing a radiation efficiency of the antenna apparatuses of FIGS. 41, 44, and 47. In table 1, the unit is dB. The cells surrounded with bold lines for the first implementation example (FIG. 44) and the second implementation example (FIG. 47) correspond to operating frequencies at which higher radiation efficiency is obtained than that of the first comparison example (FIG. 41). According to computation results of the radiation efficiency shown in table 1, it can be seen that the antenna apparatus of the implementation examples of the present invention can improve radiation efficiency over a wide band, compared to the antenna apparatus of the first comparison example. In the antenna apparatus of the first implementation example, the radiation efficiency is improved due to reduction in transmission coefficient S21. In the antenna apparatus of the second implementation example, the radiation efficiency is improved due to reduction in transmission coefficient S21 and reflection coefficient S11.

From the above results, the antenna apparatuses of the implementation examples of the present invention are operable as wideband antenna apparatuses, capable of ensuring isolation between the antenna elements, and capable of simultaneously transmitting or receiving a plurality of wideband radio signals, while having a simple and small configuration.

### Implementation Example 2

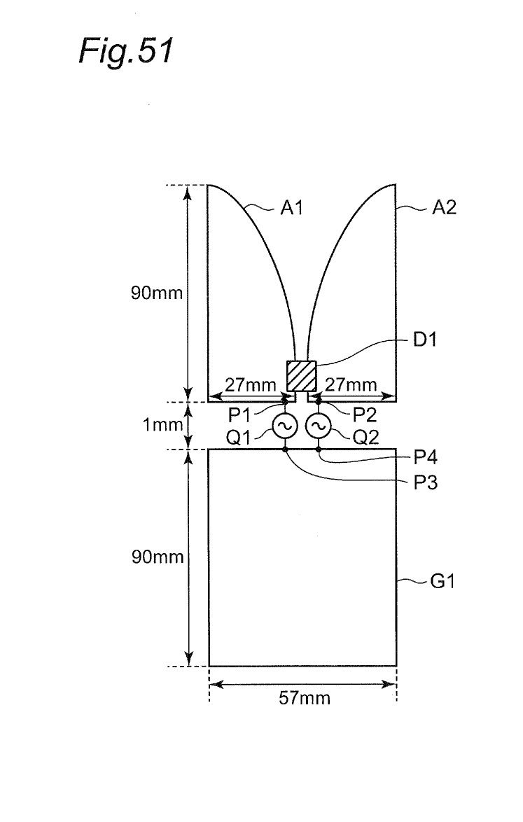

With reference to FIGS. 51 to 60, simulation results of antenna apparatuses according to the second embodiment of the present invention will be described below.

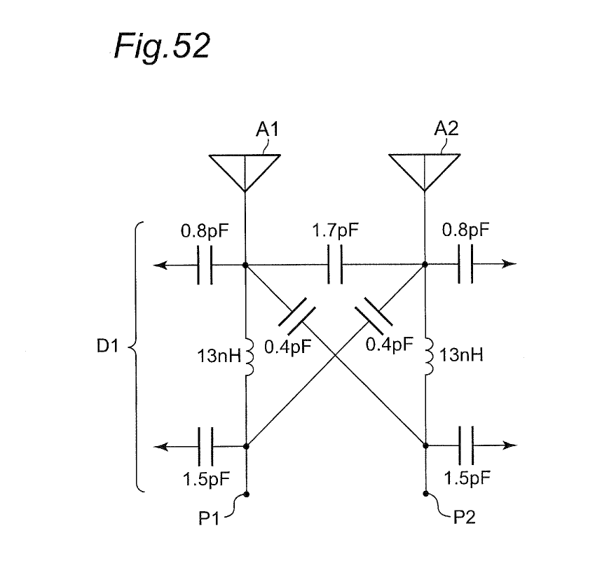

FIG. 51 is a diagram showing a schematic configuration of an antenna apparatus according to a third implementation example of the present invention. The antenna apparatus of FIG. 51 corresponds to the antenna apparatus of FIG. 19. Each of antenna elements A1 and A2 has a size of 27×90 mm, and a ground conductor G1 has a size of 57×90 mm. The antenna elements A1 and A2 are disposed on the same plane as the ground conductor G1, with a space of 1 mm from the ground conductor G1. The antenna elements A1 and A2 are tapered so that the distance between the antenna elements A1 and A2 gradually increases. FIG. 52 is an equivalent circuit diagram showing an electromagnetic coupling adjuster element D1 of FIG. 51. The electromagnetic coupling adjuster element D1 of FIG. 52 is designed so as to reduce electromagnetic coupling between the antenna elements A1 and A2 at 1000 MHz.

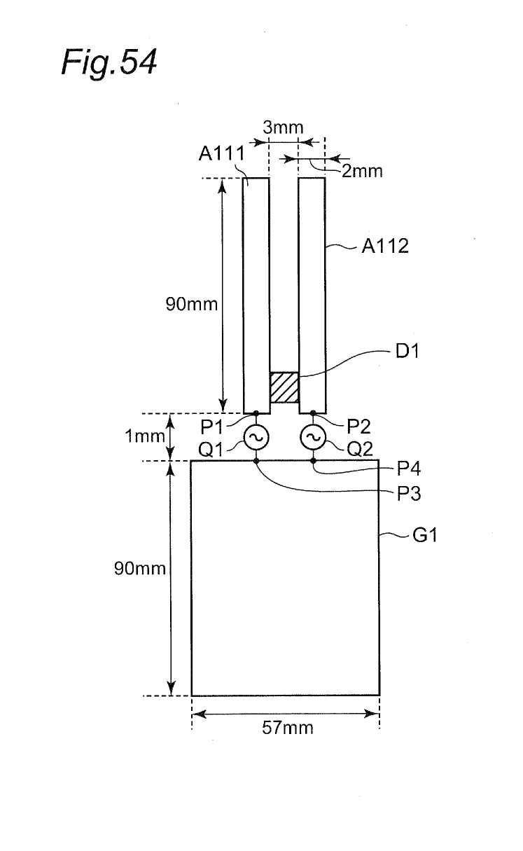

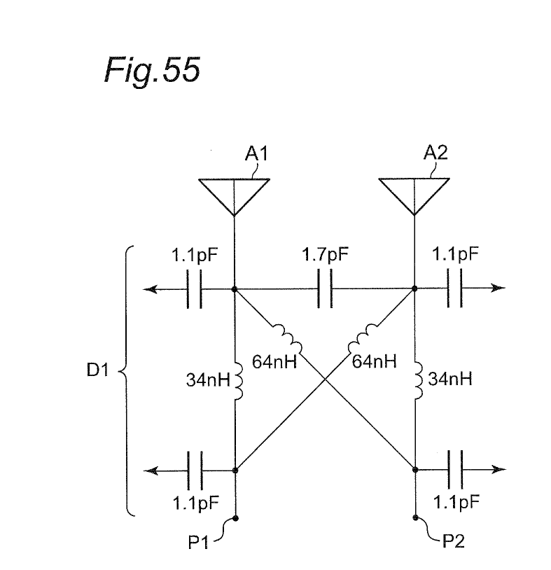

FIG. 54 is a diagram showing a schematic configuration of an antenna apparatus of a second comparison example. While the antenna apparatus of FIG. 51 is of a wideband model, the antenna apparatus of FIG. 54 is of a narrowband model in which antenna elements are disposed in parallel to each other such as those shown in Patent Literature 1. Each of antenna elements A111 and A112 has a size of 2×90 mm, and a ground conductor G1 has a size of 57×90 mm. The antenna elements A111 and A112 are disposed on the same plane as the ground conductor G1, with a space of 1 mm from the ground conductor G1. FIG. 55 is an equivalent circuit diagram showing an electromagnetic coupling adjuster element D1 of FIG. 54. The electromagnetic coupling adjuster element D1 of FIG. 55 is designed so as to reduce electromagnetic coupling between the antenna elements A111 and A112 at 1000 MHz.

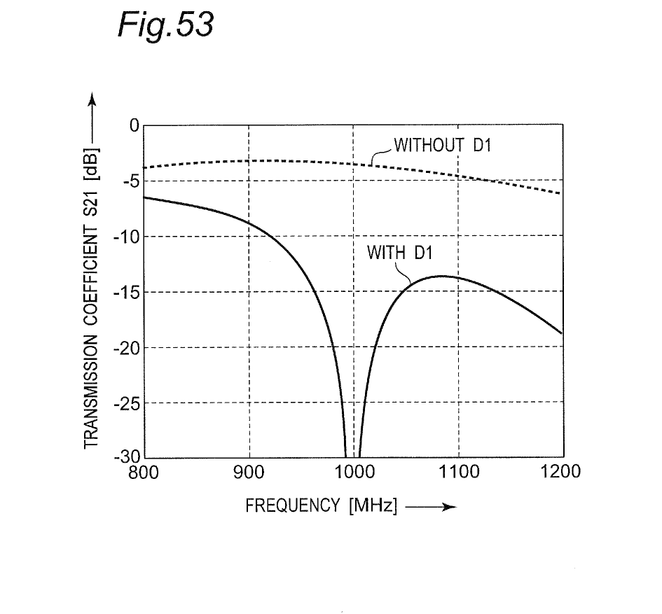

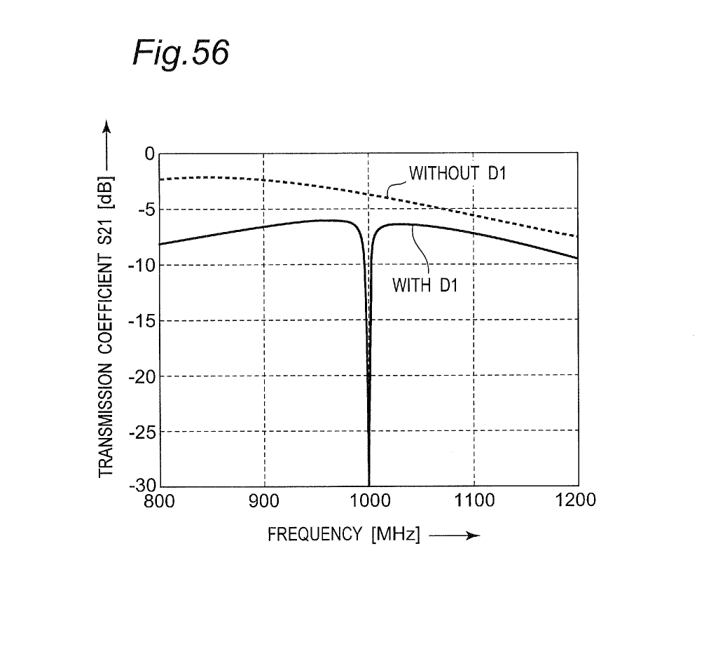

FIG. 53 is a graph showing an electromagnetic coupling between the antenna elements A1 and A2 of the antenna apparatus of FIG. 51. FIG. 56 is a graph showing an electromagnetic coupling between the antenna elements A111 and A112 of the antenna apparatus of FIG. 54. The graphs of FIGS. 53 and 56 show a transmission coefficient S21 between feed points P1 and P2 with respect to frequency. In the case in which the electromagnetic coupling adjuster element D1 is removed from the antenna apparatuses of the third implementation example (FIG. 51) and the second comparison example (FIG. 54), both results show high transmission coefficients S21 of −5 dB or more at 1000 MHz. On the other hand, in the case in which the electromagnetic coupling adjuster element D1 is provided, both results show that the transmission coefficient S21 can be reduced to −10 dB or less at 1000 MHz. However, comparing frequency bandwidths having the transmission coefficient S21 of −10 dB or less, it can be seen that while the antenna apparatus of the second comparison example has the frequency bandwidth of 6 MHz, the antenna apparatus of the third implementation example has a frequency bandwidth of 260 MHz or more, i.e., a wider frequency bandwidth by 43 times.

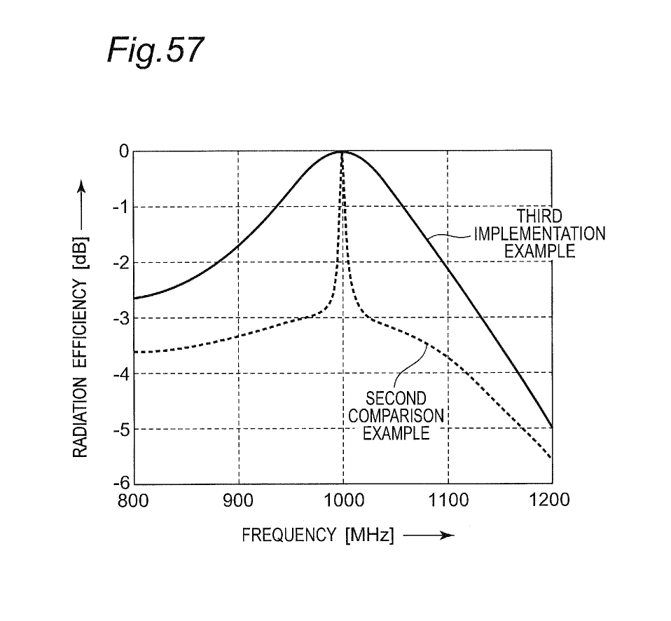

FIG. 57 is a graph showing a radiation efficiency of the antenna apparatuses of FIGS. 51 and 54. It can be seen that both the antenna apparatuses of the third implementation example and the second comparison example achieve the radiation efficiency maximized at 1000 MHz. However, comparing frequency bandwidths having the radiation efficiency of 3 dB or more, it can be seen that while the antenna apparatus of the second comparison example has the frequency bandwidth of 64 MHz, the antenna apparatus of the third implementation example has the frequency bandwidth of 330 Hz, i.e., a wider frequency bandwidth by 5 times.

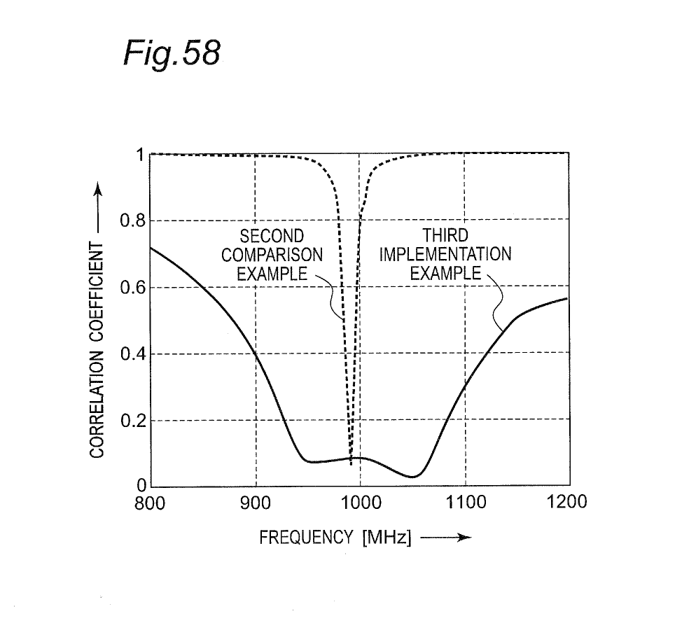

FIG. 58 is a graph showing correlation coefficients of the antenna apparatuses of FIGS. 51 and 54. It can be seen that both the antenna apparatus of the third implementation example and the second comparison example have the correlation coefficient minimized at 1000 MHz. However, comparing frequency bandwidths has the correlation coefficient of 0.6 or less, it can be seen that while the antenna apparatus of the second comparison example has the frequency bandwidth of 14 MHz, the antenna apparatus of the third implementation example has the frequency bandwidth of 400 MHz, i.e., a wider frequency bandwidth by 29 times.

Note that the electromagnetic coupling adjuster element of the implementation example is designed so as to reduce the electromagnetic coupling between the antenna elements A1 and A2 at 1000 MHz, but not limited thereto, and it is also possible to reduce the electromagnetic coupling at other frequencies.

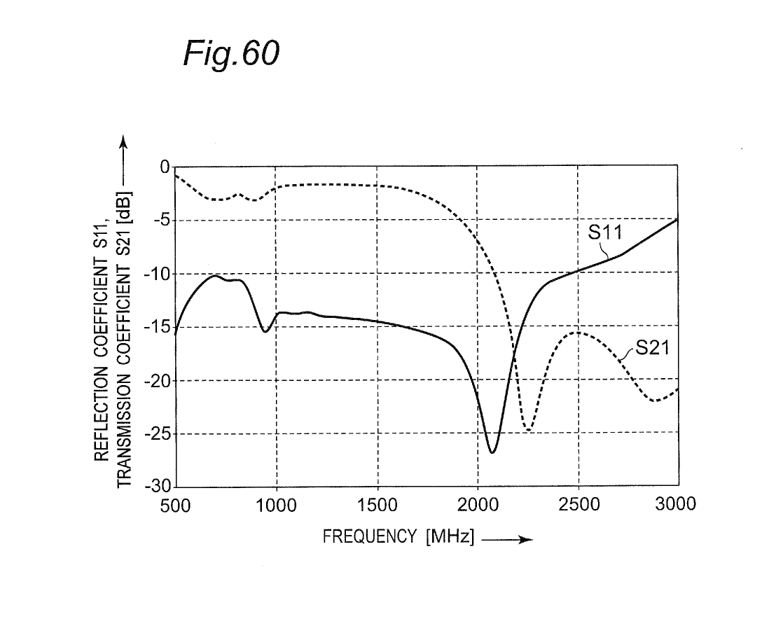

FIG. 59 is a diagram showing a schematic configuration of an antenna apparatus according to a fourth implementation example of the first embodiment of the present invention. The antenna apparatus of this implementation example includes an example of the electromagnetic coupling adjuster element D1 of FIG. 24, and antenna elements A1 and A2 and the electromagnetic coupling adjuster element D1 are integrally formed from a single conductive plate. FIG. 60 is a graph showing a reflection coefficient S11 and a transmission coefficient S21 of the antenna apparatus of FIG. 59. It can be seen that both the reflection coefficient S11 and the transmission coefficient S21 can be reduced to −10 dB or less near 2100 to 2300 MHz.

### INDUSTRIAL APPLICABILITY

As described above, antenna apparatuses of the present invention can operate as wideband antenna apparatuses capable of ensuring isolation between antenna elements, and capable of simultaneously transmitting or receiving a plurality of wideband radio signals, while having a simple and small configuration.

The antenna apparatuses of the present invention and wireless communication apparatuses using the antenna apparatuses can be implemented as, for example, mobile phones, or can also be implemented as apparatuses for wireless LANs. The antenna apparatuses can be mounted on, for example, wireless communication apparatuses for MIMO communication. In addition to MIMO communication, the antenna apparatuses can also be mounted on array antenna apparatuses capable of simultaneously performing communications for a plurality of applications (multi-application), such as adaptive array antennas, maximal-ratio combining diversity antennas, and phased-array antennas.

### REFERENCE SIGNS LIST

A1, A2, A1a to A1g, A1a to A2g, A11 to A14, and A21 to A26: ANTENNA ELEMENT,
G1, G2, G3, and G4: GROUND CONDUCTOR,
D1, D2, D3, and D4: ELECTROMAGNETIC COUPLING ADJUSTER ELEMENT,
I1 and I3: CURRENT ON ANTENNA ELEMENT A1,
I2: CURRENT ON ANTENNA ELEMENT A2,
Id1: CURRENT ON ELECTROMAGNETIC COUPLING ADJUSTER ELEMENT D1,
Id2: CURRENT ON ELECTROMAGNETIC COUPLING ADJUSTER ELEMENT D2,
N1 to N4: SLIT,
Pa, Pb, and Pc: REFERENCE POINT,
P1 and P2: FEED POINT,
P3 and P4: GROUND POINT,
P5 and P6: END POINT IN RADIATION DIRECTION OF ANTENNA ELEMENT A1 AND A2,
Q1 and Q2: SIGNAL SOURCE,
1 to 9: SUSCEPTANCE ELEMENT,
11, 13, and 15: AMPLITUDE ADJUSTER,
12, 14, and 16: PHASE SHIFTER,
21: CONDUCTIVE ELEMENT,
31 and 32: SHORT-CIRCUIT CONDUCTOR.

1. An antenna apparatus comprising at least two antenna elements, each made of a conductive plate having a circumference,
wherein the antenna elements are provided along a reference axis passing through a first position and a second position of the antenna apparatus, and are provided close to a section between the first position and the second position,
wherein each of the antenna elements has a first portion and a second portion along the circumference of the antenna element, the first portion is close to the reference axis and electromagnetically coupled to the other antenna element, and the second portion is remote from the reference axis,
wherein the first portions of the respective antenna elements are shaped so that the antenna elements are the closest to each other near the first position, and a distance between the antenna elements gradually increases from the first position to the second position, and
wherein the antenna apparatus has feed points provided on the antenna elements, respectively, and near the first position.

2. The antenna apparatus as claimed in claim 1,
wherein each of the feed points is provided close to the reference axis.

3. The antenna apparatus as claimed in claim 1,
wherein each of the feed points is provided at a distance from the reference axis.

4. The antenna apparatus as claimed in claim 1,
wherein the antenna elements simultaneously transmit or receive different radio signals when being excited through their respective feed points.

5. The antenna apparatus as claimed in claim 1,
wherein the antenna elements are symmetric about the reference axis.

6. The antenna apparatus as claimed in claim 1,
wherein the antenna elements are asymmetric about the reference axis.

7. The antenna apparatus as claimed in claim 1,
wherein each of the antenna elements has a slit in the first portion.

8. The antenna apparatus as claimed in claim 7,
wherein in each of the antenna elements, the slit has a portion extending toward a corresponding feed point.

9. The antenna apparatus as claimed in claim 1, comprising two antenna elements, and a ground conductor made of a conductive plate,
wherein the two antenna elements are provided on the same plane as that of the ground conductor.

10. The antenna apparatus as claimed in claim 1, comprising:
a ground conductor made of a conductive plate;
two antenna elements provided in parallel so as to overlap on the ground conductor, with a distance from the ground conductor; and
short-circuit conductors connecting the two antenna elements to the ground conductor, respectively, whereby the antenna apparatus is configured as a planar inverted-F antenna apparatus.

11. The antenna apparatus as claimed in claim 1,
wherein each of the antenna elements is a dipole antenna.

12. The antenna apparatus as claimed in claim 1, comprising a ground conductor made of a conductive plate,
wherein the antenna elements are vertically provided on the ground conductor.

13. The antenna apparatus as claimed in claim 1,
wherein each of the antenna elements is bent at least one position.

14. The antenna apparatus as claimed in claim 1, further comprising an electromagnetic coupling adjuster element provided in the first portions of the respective antenna elements so as to connect the antenna elements with each other, and adjusting electromagnetic coupling between the antenna elements in a first frequency band,
wherein the electromagnetic coupling adjuster element forms a current path between any pair of a first and a second antenna element among the antenna elements, through which a current flows, the current substantially canceling out a current flowing through the second antenna element due to electromagnetic coupling between the first and second antenna elements, when feeding the first antenna element at a feed point in the first frequency band.

15. The antenna apparatus as claimed in claim 14,
wherein the electromagnetic coupling adjuster element is a low-coupling circuit including a plurality of circuit elements having susceptance values.

16. The antenna apparatus as claimed in claim 14,
wherein the electromagnetic coupling adjuster element includes a plurality of amplitude adjusters and a plurality of phase shifters.

17. The antenna apparatus as claimed in claim 14,
wherein the electromagnetic coupling adjuster element is a conductive element.

18. The antenna apparatus as claimed in claim 17,
wherein the conductive element is integrally formed with the antenna elements.

19. The antenna apparatus as claimed in claim 14,
wherein the electromagnetic coupling adjuster element includes a filter.

20. The antenna apparatus as claimed in claim, 14, comprising at least one additional electromagnetic coupling adjuster element provided in the first portions of the respective antenna elements so as to connect the antenna elements with each other, and adjusting electromagnetic coupling between the antenna elements in a frequency band different from the first frequency band.

21. A wireless communication apparatus comprising an antenna apparatus,
wherein the antenna apparatus comprising at least two antenna elements, each made of a conductive plate having a circumference,
wherein the antenna elements are provided along a reference axis passing through a first position and a second position of the antenna apparatus, and are provided close to a section between the first position and the second position,
wherein each of the antenna elements has a first portion and a second portion along the circumference of the antenna element, the first portion is close to the reference axis and electromagnetically coupled to the other antenna element, and the second portion is remote from the reference axis,
wherein the first portions of the respective antenna elements are shaped so that the antenna elements are the closest to each other near the first position, and a distance between the antenna elements gradually increases from the first position to the second position, and
wherein the antenna apparatus has feed points provided on the antenna elements, respectively, and near the first position.
